(19) United States
(12) Patent Application Publication
(10) Pub. No.: US 2015/0051385 A1
(43) Pub. Date: Feb. 19, 2015

(54) Liquid / Liquid Separation of Lignocellulosic Biomass to Produce Sugar Syrups and Lignin Fractions

(71) Applicant: ARCHER DANIELS MIDLAND COMPANY, DECATUR, IL (US)

(72) Inventor: Thomas Binder, Decatur, IL (US)

(21) Appl. No.: 14/386,142

(22) PCT Filed: Apr. 10, 2013
(86) PCT No.: PCT/US2013/035879

§ 371 Date: Sep. 18, 2014

Related U.S. Application Data
(60) Provisional application No. 61/638,544, filed on Apr. 26, 2012.

(51) Int. Cl. C08B 1/00; C07G 1/00

(52) U.S. Cl. CPC C08B 1/003; C07G 1/00
USPC 530/507; 127/37

(57) ABSTRACT

A process for production of C5 and C6 sugar enriched syrups from lignocellulosic biomass and fermentation products therefrom is described. A lignocellulosic biomass is treated with acetic acid with washing thereof with a C₁-C₂ acid-miscible organic solvent, (e.g., ethyl acetate). A soluble hemicellulose and lignin enriched fraction is obtained separately from a cellulose pulp enriched fraction and lignin is removed from the soluble hemicellulose fraction. The soluble hemicellulose and lignin enriched fraction is subjected to liquid/liquid separation to obtain an aqueous phase enriched in C5 sugars and C6 sugars and reduced in content of acetic acid. The syrup is suitable for fermentation. The process also produces fractions of organic-insoluble lignin, organic-soluble lignin, and acetate salts.

### CROSS REFERENCE TO RELATED APPLICATION[S]

This application claims priority to Patent Cooperation Treaty Application No. PCT/US12/56593, filed Sep. 21, 2012, now pending, which claims the benefit of Provisional Application 61/638,544, entitled C1-C2 Organic Acid Treatment of Lignocellulosic Biomass to Produce Acylated Cellulose Pulp, Hemicellulose, Lignin and Sugars and Fermentation of the Sugars, filed Apr. 26, 2012. The patent applications identified above are incorporated herein by reference in their entirety to provide continuity of disclosure.

### STATEMENT OF FEDERAL SPONSORED RESEARCH

This invention was made with government support under department of Energy Grant No: DE-EE0002870. The federal government has certain rights in this invention.

### BACKGROUND OF THE INVENTION

The hydrolysis of cellulose and hemicelluloses to monomeric sugars is a key prerequisite to the commercial conversion of lignocellulosic feedstocks such as corn stover, corn fiber hulls, soybean hulls, wheat straws, sugarcane bagasse, sweet sugar beet pulp and other forms of plant biomass derived from energy crops consisting of perennial grasses such as switch grass or miscanthus, soft and/or hardwoods as well as pulp and waste paper residues to monomeric sugars.

Much of cellulose hydrolysis has focused on producing a pulp stream suitable for pulp and paper industry applications rather than recovering fermentable C5 and C6 sugars. The Acetosolv process uses concentrated acetic acid and hydrochloric acid for pulping, allowing hydrolytic degradation of lignin and hemicelluloses under mild conditions. In Acetosolv processes, biomass, such as wood, is delignified by cooking for a set time and temperature in a water mixture containing greater than 50% acetic acid. After cooking, residual pulp is separated from the dissolved solids and the pulp is further washed with acetic acid /water and then finally with water, ultimately producing pulp, sulfur-free lignin and a fraction enriched sugars and oligosaccharides but contaminated with organic acids.

The conversion of lignocellulosic biomass to monomeric sugars, however, poses many technical challenges for economical uses of the monomeric sugars, especially as feedstocks for making products, such as ethanol, by fermentation of the sugars. Solutions to those challenges were presented in United States Provisional Application 61/638,544, entitled C1-C2 Organic Acid Treatment of Lignocellulosic Biomass to Produce Acylated Cellulose Pulp, Hemicellulose, Lignin and Sugars and Fermentation of the Sugars, filed Apr. 26, 2012, and Patent Cooperation Treaty Application No. PCT/US12/56593, filed Sep. 21, 2012, now pending. The present disclosure is directed to improvements to the processes and compositions of that disclosure. The processes of that disclosure are carried out using an excess of solvent added to concentrated hemicellulose and lignin aqueous phase to precipitate the hemicellulose and lignin, followed by filtration to recover the hemicellulose/lignin. This is referred to herein as the filtration process.

There is therefore still a need in the art to develop an integrated and more cost-effective approach for recovery and purification of fermentable C5 and C6 sugars without toxic byproducts and recovery of lignin fractions, while reducing the quantity of water and solvent used.

### SUMMARY OF THE INVENTION

The methods and materials made thereby described herein overcome many of the foregoing technical challenges. The methods include use of a mild acetic acid in conjunction with a suitable C₁-C₂ acid-miscible organic solvent in initial rounds of hydrolysis to separate acid soluble hemicellulose and lignin from a cellulose pulp. The use of the acetic acid results in esterification of the hemicellulose and cellulose, which is overcome by enzymatic and/or chemical de-esterification prior to, or in conjunction with, further hydrolysis of these fractions with an appropriate mixture of cellulolytic and hemicellulolytic enzymes. An esterase enzyme is included in preferred embodiments. The use of a non-ionic detergent in the enzymatic hydrolysis substantially increases the rate of catalytic conversion to suitable C5 and C6 enriched sugar syrups. Further these are used in staged fermentation processes to achieve greater than 8% ethanol production in the fermentation broth. The results obtained were surprising in that contrary to published articles, the hydrolysis of cellulose to glucose can proceed without noticeable inhibition of cellulase enzyme activity and that ethanol concentrations over 5% are not detrimental to enzyme activities in the blend tested. This suggests that there is little to no feedback inhibition with the new commercial mixed blends and that precipitation of proteins is not significant. The above can be explained based on more balance in enzyme activity in the new commercial blends and possibly greater purity in the blended product thereby mitigating co-precipitation with other non-essential proteins.

Another aspect includes efficient liquid/liquid separation methods for purification of the sugars derived from acid soluble hemicellulose derived from lignocellulosic biomass. The liquid/liquid separation methods enable separation of an aqueous phase enriched in C5 and C6 sugars and organic-insoluble lignin from an organic supernatant phase enriched in organic-soluble lignin and acetate salts. An organic-insoluble lignin and a sugar syrup enriched in C5 and C6 sugars are recovered from the aqueous phase by water-induced coagulation, heating, and filtration. Acidification of the sugar syrup enriched in C5 and C6 sugars allows further liquid/liquid separation steps carried out by applying solvent to the sugar syrup enriched in C5 and C6 sugars. In this process, acetic acid is removed from the sugar syrup enriched in C5 and C6 sugars to yield acetic acid-depleted C5+C6 sugars enriched in C5 and C6 sugars and a solution of recovered acid. In an alternative embodiment, after water-induced coagulation and heating, the organic-insoluble lignin is contacted with a second amount of water and filtered to yield organic-insoluble lignin. In further embodiments, the organic supernatant phase enriched in organic-soluble lignin and acetate salts is subject to evaporation to recover C₁-C₂ acid-miscible organic solvent and acetic acid separate from an aqueous supernatant syrup enriched in organic-soluble lignin and acetate salts. The C₁-C₂ acid-miscible organic solvent and acetic acid may be condensed to recover solvent and acid. In further embodiments, liquid/liquid separation of the aqueous supernatant syrup is carried out by contacting it with sufficient water to induce phase separation, yielding an aqueous phase enriched in acetate salts and a phase enriched in organic-soluble lignin. In yet another embodiment, one or more process streams enriched in C5 and C6 sugars may be contacted with a microorganism to produce a fermentation product. In an alternative embodiment, the C₁-C₂ acid-miscible organic solvent is not a halogenated solvent. In yet another embodiment, organic-insoluble lignin obtained by the methods presented herein is presented. In another embodiment, organic-soluble lignin obtained by the methods presented herein is presented. In selected embodiments, the organic-insoluble lignin or the organic-soluble lignin comprises lignin derived from softwood, such as conifers, spruce, cedar, pine and redwood; lignin derived from hardwood, such as maple, poplar, oak, eucalyptus, and basswood; lignin derived from stalks, such as straw, maize, canola, oat, rice, broomcorn, wheat, soy, barley, spelt, and cotton; lignin derived from grass, such as bamboo, miscanthus, sugar cane, switchgrass, reed canary grass, cord grass, and combinations of any thereof. In other embodiments, the lignocellulosic biomass has a water content not greater than 40% wt/wt, not greater than 20% wt/wt, or not greater than 10% wt/wt. In yet another embodiment, acetate salts suitable for fertilizer are obtained from cellulosic biomass.

### BRIEF DESCRIPTION OF THE DRAWINGS

FIG. 1 is a schemata for an overall embodiment of a biorefinery for processing lignocellulosic biomass to form a cellulose pulp, a hemicellulose fraction and a lignin fraction and subsequent formation of C5 and C6 sugars for use in making ethanol or other products by fermentation.

FIG. 2 illustrates an embodiment of a method incorporating acetic acid and C₁-C₂ acid-miscible organic solvent for preparation of a cellulose pulp, a hemicellulose fraction and a lignin fraction from lignocellulosic biomass.

FIG. 3 is a diagram of FTIR spectra and illustrates the difference in of corn stover cellulose pulp (top trace) and ammonium hydroxide treated corn stover pulp (lower trace).

FIG. 4 is a diagram of FTIR spectra confirming the absence of esterified acetic acid in the ammonium hydroxide treated corn stover pulp.

FIG. 5 is a graph showing the amount of glucose released from deacetylated corn stover by cellulase treatment.

FIG. 6 is a graph showing the results of shake flask fermentation flasks by yeast strain 424a of enzyme hydrolyzed at 20% solids cellulose pulp 218 with surfactant addition.

FIG. 7 is a schemata illustrating one optimal method for a two stage semi-simultaneous hydrolysis and fermentation process to produce ethanol from lignocellulosic biomass.

FIG. 8 is a graph illustrating the time course for production of ethanol and simultaneous utilization of the C5 sugar xylose during an exemplary first stage fermentation by yeast strain 424a conducted in laboratory shake flasks in duplicate. EFT=Elapsed fermentation time (hours).

FIG. 9 is a schemata for an overall embodiment of a biorefinery for processing lignocellulosic biomass by liquid/liquid separation to substantially reduce volumes of solvent and prevent emulsion formation, to form an organic-soluble lignin fraction, an organic-insoluble lignin fraction, and C5 and C6 sugars for use in making ethanol or other products by fermentation.

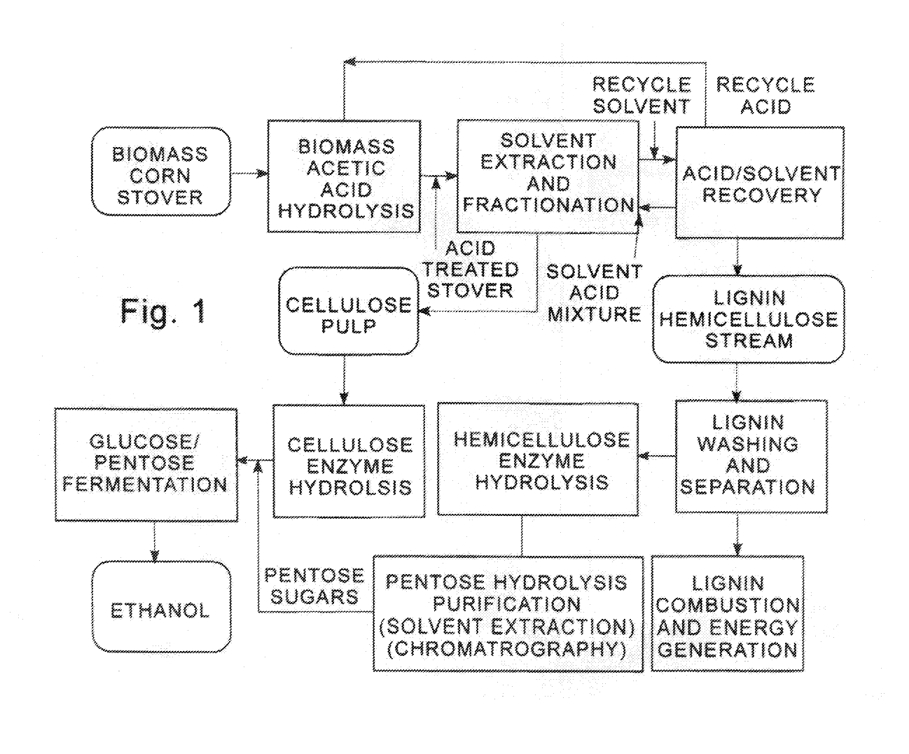

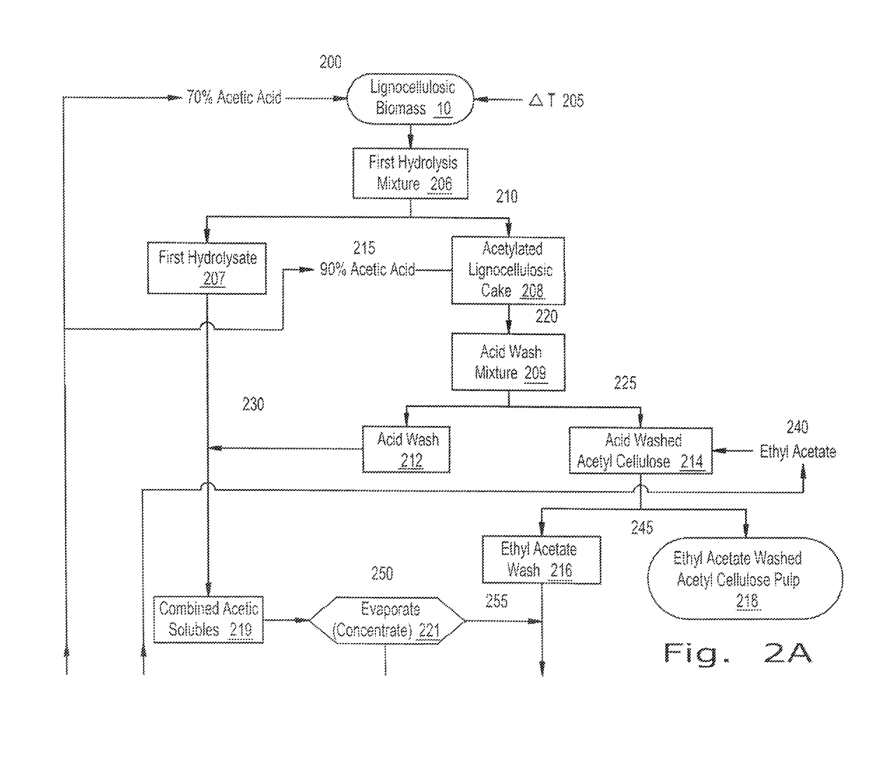

### DETAILED DESCRIPTION OF THE INVENTION

“Lignocellulosic biomass” means a plant material wherein the majority of the carbohydrates are in the form of cellulose and hemicellulose as distinct from starch and sugars. For the invention to be most workable the lignocellulosic biomass should have a moisture content of less than 40% and in typical embodiments the moisture content should be less than 30%, preferably less than 20% and most preferably less than 10%. Also it is preferable to use biomasses that have relatively low protein content because higher amounts of protein interfere with processing steps and contaminate the finally recovered hemicellulose and lignin fractions. The protein content should be less than 10% wt/wt of the biomass. Less than 5% is preferred in most embodiments. Suitable examples include wood, grasses, the stalks of cereal grains such as wheat (straw), corn (stover), barley, millet, and rice, as wells as the residual plant waste from harvesting dicotyledonous crops including some hulls of legumes and grains. Non suitable lignocellulosic biomasses having too much protein include, for example, corn hulls (a.k.a. the “corn fiber” stream from a wet mill corn processing operation).

Acetic acid may include up to 30% water. Although acetic acid is used as the preferred acid in the present disclosure, formic acid would also be suitable.

A “C₁-C₂ acid-miscible organic solvent” is a non-acidic organic solvent that is miscible with acetic acid and able to form a precipitate of hemicellulose and lignin from an acetic acid solution containing the same, with the proviso only that the C₁-C₂ acid-miscible organic solvent is not a halogenated solvent. The organic solvent used has following characteristics: the solubility of sugars in the solvent must be low, and at least a subfraction of the lignin must be partially soluble in the solvent. Such solvents are slightly polar. Preferably the solubility of water in the organic solvent should be low. Further, the polarity of the solvent should not be too low to effectively extract acetic acid from water. Suitable examples include low molecular weight alcohols, ketones and esters, such as C₁-C₄ alcohols, acetone, ethyl acetate, methyl acetate, and methyl ethyl ketone, and tetrahydrofuran.

“Acylate” and “acylated” means formation of an ester bond between a sugar or sugar residue of polysaccharide and an organic acid.

“Liquid/liquid extraction” and “liquid/liquid separation” mean methods to separate compounds based on their relative solubility in two different immiscible liquids.

“Partitioning” means the behavior of a compound or mixture of compounds in the presence of two immiscible phases. The compound or mixture of compounds is said to partition into a given phase when, on contact with two immiscible phases, the concentration of the compound or mixture of compounds in one of the phases is greater than the concentration of that compound or mixture of compounds in the other phase.

One improvement of the present disclosure over the filtration process described in Patent Cooperation Treaty Application No. PCT/US12/56593 is an increase in the level of hydrolysis of lignocellulosic biomass that can be carried out. The level of monosaccharide released in the hydrolysis of lignocellulosic biomass for the filtration process must be relatively low due to the use of solvents that precipitate both hemicellulose and lignin, simultaneously extracting entrained water from the hemicellulose. Higher levels of hydrolysis render solvent use difficult and costly, as the affinity of the monosaccharides for water is much higher than the affinity of oligosaccharides for water. Thus, excessively high levels of solvent, more polar solvents, or very high shear are required.

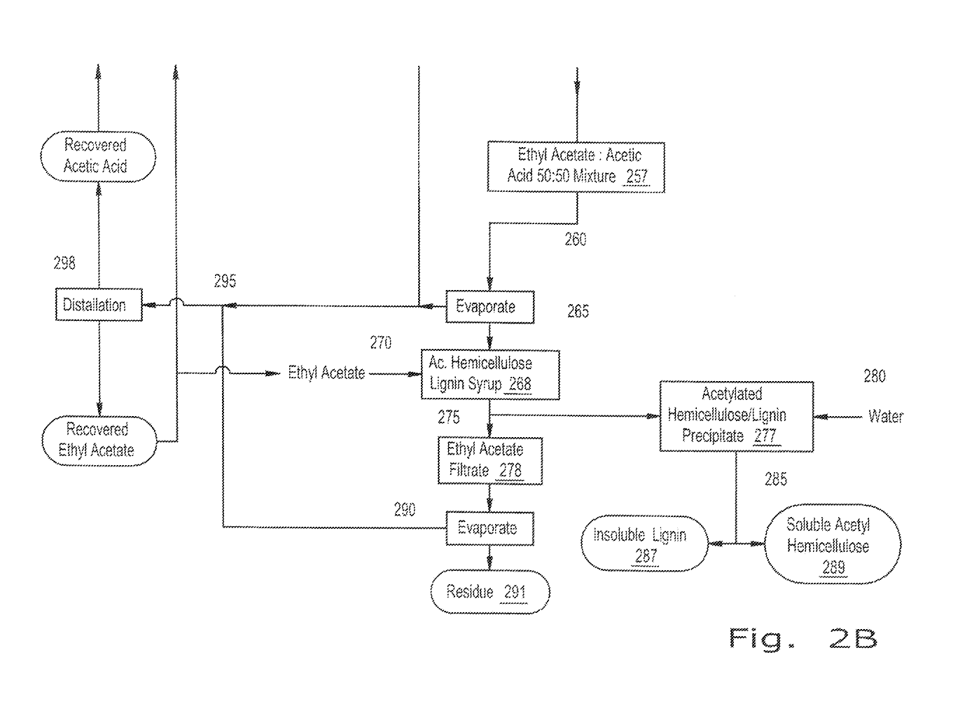

A further improvement of the present disclosure over the filtration process is that the processes of the present disclosure require less solvent. Thus, the process streams are operated with higher concentrations of desired components. Because the present disclosure makes use of liquid/liquid separation instead of filtration in certain steps, viscosity limitations inherent to the filtration process are obviated. The viscosity of process streams is influenced by the degree of initial hydrolysis of lignocellulosic biomass. One technical problem of the filtration process is that the concentration of solids of the concentrated hemicellulose and lignin syrup 268 (see FIG. 2) by evaporation of the C₁-C₂ acid/organic solvent mixture 257 is limited the high viscosity that develops as the evaporation is carried out. When filtration is used for separation, the evaporation can only be carried out to form a concentration of about 40% solids in the concentrated hemicellulose and lignin syrup because the subsequent filtration step becomes impractical due to the high viscosity. In the present disclosure, the use of liquid/liquid separation permits the evaporation to be carried out until at least a concentration of 52% solids in the concentrated hemicellulose and lignin syrup 268 is reached. The higher level of solids concentration permits smaller amounts of acid and solvent to be used in subsequent purification steps.

A further improvement of the present disclosure over the filtration process is a reduction in the amount of water used in the process. Because the filtration process uses significant quantities of water for washing and separation, subsequent separation of acetic acid is difficult and costly due to the well-known formation of zeotropic mixtures of acetic acid and water. Although these mixtures are not true azeotropes, the recovery of acetic acid from a zeotropic mixture of acetic acid and water is economically impractical. The processes of the present disclosure use substantially reduced quantities of water. Consequently, the costs of recovery of acid and solvent, especially the separation of water and acid mixtures, become less burdensome.

A further improvement of the present disclosure over the filtration process is the reduction of solvent volume used to contact concentrated hemicellulose and lignin syrup 268. When precipitation of the hemicellulose and lignin from concentrated hemicellulose and lignin syrup 268 having a dissolved solids content of 40% was carried out, 3 to 4 parts of ethyl acetate was added to one part of concentrated hemicellulose and lignin syrup 268 to extract water and produce a filterable precipitate. In the present disclosure, only one part of ethyl acetate is added to one part of concentrated hemicellulose and lignin syrup 268 having a dissolved solids content of 52%. Subsequent phase portioning brought about the desired separation of hemicellulose and organic-insoluble lignin from aqueous acetate salts and organic-soluble lignin with much less ethyl acetate. The present disclosure overcomes a major cost by obviating dilution of the acetic acid with water and the high costs in energy and equipment associated with recovering the acetic acid from this stream in concentrations suitable for recycle. Further, when the water precipitation step of the filtration process is employed to recover hemicellulose for hydrolysis to be used for fermentation, the concentration of acetic acid in the resulting hemicellulose stream can render the hemicellulose unsuitable for fermentation due to inhibitory concentrations of acetic acid. This problem is ameliorated by the present methods.

A further improvement of the present disclosure over the filtration process is the obviation of emulsion formation in the solvent-based recovery of acetic acid from a hemicellulose/sugar enriched fraction 322. In the filtration-based process, the greater content of water in the hemicellulose/sugar enriched fraction causes the formation of an intractable emulsion if an attempt is made to extract acetic acid with a solvent. The present disclosure uses reduced contents of water, so emulsion formation does not take place.

A further improvement of the present disclosure over the filtration process is the recovery of two fractions of lignin-organic soluble lignin and non-organic soluble lignin. These novel lignin fractions can be expected to have different properties; in fact, corresponding lignin fractions from any lignocellulosic biomass can be expected to have properties unique to the source biomass.

Acetic acid hydrolysis. FIG. 2 illustrates one aspect of the invention pertaining to separation and recovery of hemicellulose and lignin from a lignocellulosic biomass 10 utilizing acetic acid and C₁-C₂ acid-miscible organic solvent. The process is illustrated with acetic acid as the C₁-C₂ acid and ethyl acetate as the C₁-C₂ acid-miscible organic solvent as one preferred process, however, formic acid or mixtures of formic and acetic acid may also be used as substitutes for acetic acid and other C₁-C₂ miscible organic solvents may be used as substitutes for ethyl acetate.

A lignocellulosic biomass 10, exemplified by corn stover, is mixed with the acetic acid at step 200. The final ratio of the acetic acid to the lignocellulosic biomass should preferably be in the range of 3:1 to 5:1 on a wt:wt basis acid:dry solids, which excludes the water content of the acetic acid and lignocellulosic biomass. Lower and higher ratios of acetic acid to dry solids will work, but not as economically. The concentration of the acetic acid to use is variable depending on the moisture content of the lignocellulosic biomass 10 so long as the aforementioned ratio of acetic acid to dry solids is achieved. With corn stover lignocellulosic biomass 10 dried to a moisture content of about 8%, 4.5 liters of 70% acetic acid per kilogram of biomass was adequate.

When formic acid is used, the water content should be lower to achieve effective solubilization of lignin. Formic acid concentrations of 80-90% work well, whereas higher water content does not. Because acetic is more hydrophobic it tolerates more water to solubilize the same amount of lignin. At step 205 the acidified lignocellulosic biomass 10 is heated to a temperature and for a time sufficient to hydrolytically solubilize a first fraction of hemicellulose and lignin from the biomass 10 forming a first hydrolysis mixture 206. Preferably the heating 205 is done with agitation or with physical tumbling agents to apply mechanical force to the lignocellulosic biomass 10 during the heating and hydrolysis process 200/205. Optionally, in certain embodiments, the acetic acid used in the initial hydrolysis 200/205 may be supplemented with no more than 0.25% to 1% w/v of a mineral acid such as HCl or sulfuric acid. The inclusion of small amounts mineral acid results in improved hydrolysis and solubilization of hemicellulose, however, it also leads to a degradation of some of solubilized C5 sugars and to increased inorganic (ash) content, especially of the hemicellulose fraction that will obtained. Further, if it is desirable to supplement the acetic acid with sulfuric acid, it is additionally necessary to neutralize the sulfuric acid and to recover it as a sulfate salt. Residual sulfur is not compatible with certain catalysts that may be used for chemical conversion of sugars that may be desirable in certain biorefinery operations, and also may cause formation of sulfate esters that may interfere with subsequent enzymatic steps using cellulolytic, hemicellulolytic and esterase enzymes as described hereafter and in co-pending provisional application No. 61/538,211 entitled Cellulolytic Enzyme Compositions and Uses Thereof Accordingly, in some embodiments sulfuric acid is specifically excluded from the acid hydrolysis steps 205 and 215.

Temperature and time conditions for hydrolytic release of hemicellulose and lignin are critical. If the temperature is too low or the time too short, there will be insufficient hydrolytic release of hemicellulose and lignin. Unexpectedly it was discovered that over-hydrolysis is detrimental to the recovery of useable materials. If the temperature is too high or the time is too long, unwanted hydrolysis of cellulose and hemicellulose to monosaccharides may occur and other reaction products will be formed that interfere with the subsequent precipitation of hemicellulose and lignin, leading to the formation of a gummy precipitate when reaction temperatures and/or times are excessive. The temperature should be in the range of 120-280° C. and the time should be in the range of 5-40 minutes. In a laboratory embodiment with 70% acetic acid, the temperature was raised to 165° C. in 10 minutes followed by quick reduction to a temperature of 150° C. over 3 minutes with gradual cooling thereafter to 100° C. over a 30 minute period. In an industrial plant embodiment, a temperature of 165° C. is used for a period of 1-10 minutes.

The first hydrolysis step 200/205 forms the first hydrolysis mixture 206 containing a soluble first hydrolysate 207 enriched in hemicellulose and lignin and an insoluble lignocellulosic residue fraction. At step 210 these are separated by a suitable technique such as filtration or centrifugation. The solid material is recovered as a first lignocellulosic cake 208 that is at least partially depleted of hemicellulose and lignin and that contains at least partially acylated cellulose (e.g., acetyl cellulose esters or formyl cellulose esters for acetic and formic acid, respectively). At step 215 the first recovered lignocellulosic cake 208 is thoroughly washed with the acetic acid to further release bound hemicellulose and lignin. Preferably the acetic acid used for the wash is warmed to a temperature of about 40-50° C. Optionally, but not necessarily, the acid wash of the first lignocellulosic cake 208 may include a second round of heat treatment using the same conditions of acid and heat as were used in the first round at steps 200/205 mentioned herein before Whether or not the acid wash 215 should be done at elevated temperatures depends on the hemicellulose and lignin content and structure in the lignocellulosic biomass 10. When the lignocellulosic biomass 10 has a high lignin or hemicellulose content as in the case of woody sources, then a second round of heating 220 is preferred. The concentration of the acetic acid is preferably higher at this wash step 215 than at hydrolysis step 200 because of dilution with water liberated by hydrolysis and from the water released by the lignocellulosic cake 208 from the initial treatment with the acetic acid used at step 200. In the case of corn stover as the lignocellulosic biomass 10, 90% acetic acid was used in the acid wash step 215. The acid wash produces an acid wash mixture 209 that at step 225 is recovered by centrifugation or filtration into a liquid acid wash fraction 212 containing further hemicellulose and lignin separated away from the acid washed lignocellulosic cake 214, that has been depleted of a majority of the hemicellulose and lignin and which contains further acylated cellulose.

In a preferred process, at step 230 the first hydrolysate fraction 207 and the acid wash fraction 212 are mixed to form combined solution of acetic acid solubles 219. This combined acetic acid solubles solution 219 is then preferably evaporated at step 250 to achieve a dissolved solids content of at least 30% wt/vol. forming a concentrated soluble hydrolysate 221.

Separately, at step 240, the second lignocellulosic cake 214 is washed with ethyl acetate or other C₁-C₂ acid-miscible organic solvent to remove the acetic acid and remaining hemicellulose and lignin from the second lignocellulosic cake 214. The total amount of the C₁-C₂ miscible organic solvent to use in washing 240 the second lignocellulosic cake 214 is preferably about the same quantity as the second amount of C₁-C₂ acid 215 used in the second hydrolysis step 220. The wash may be done with the total volume in batch, or preferably the total volume is applied in discrete increments to maximize removal of the acetic acid and retained hemicellulose and lignin. The amount of acetic acid-miscible organic solvent to use for the wash should be sufficient to thoroughly wash the acetic acid from acetylated cellulose pulp. A total wash of at least 3 volumes (liters) of acetic acid-miscible organic solvent per weight (kg) of pulp is suitable. The total wash is preferably delivered into three or more discrete successive stages for delivery of the entire wash amount.

The wash results in a liquid organic solvent/acetic acid wash fraction 216 which is separated at step 245 from the second lignocellulosic cake 214 by filtration. The filtration medium employed at step 245 should have pores large enough to permit passage of insoluble hemicellulose and lignin with the organic wash, yet small enough to retain the solid mass of higher molecular weight cellulose fibers in the acid washed cake 214 which after filtration is retained as organic solvent washed acyl-cellulose pulp 218. A suitable filtration medium for this filtration step 245 was one with pore sizes corresponding to a 60 mesh screen (nominal sieve diameter of 250 microns).

At step 255 the organic solvent/acetic acid wash fraction 216 is combined in roughly equal volumes with the concentrated hydrolysate 221 forming a C₁-C₂ acid/organic solvent mixture 257, which is agitated for a sufficient time to dissolve any insoluble hemicellulose and lignin obtained in the organic solvent wash 216. The C₁-C₂ acid/organic solvent mixture 257 is then evaporated at step 265 to a dissolved solids content of 40% wt/vol to form a concentrated hemicellulose and lignin aqueous phase 268.

In a first preferred process for further processing the concentrated hemicellulose and lignin aqueous phase 268, a second amount of the C₁-C₂ miscible organic solvent is added to the concentrated hemicellulose and lignin aqueous phase 268 in an amount sufficient to precipitate the hemicellulose and lignin. At a dissolved solids content of 40% with a mixture of acetic acid and ethyl acetate as the solvent system for the aqueous phase 268, a ratio of 1 part aqueous phase 268 to 3 to 4 parts ethyl acetate was sufficient to produce a filterable precipitate. At step 275 this hemicellulose and lignin precipitate 277 is separated from ethyl acetate filtrate 278. Optionally, the hemicellulose and lignin precipitate 277 may be washed with further quantities of the C₁-C₂ acid-miscible organic solvent to remove residual C₁-C₂ acids.

The hemicellulose and lignin precipitate is then mixed with warm water at step 280 to dissolve the hemicellulose forming a soluble hemicellulose aqueous fraction 289, and an insoluble lignin fraction 287, which are separated by filtration or centrifugation at step 285. Optionally, the insoluble lignin fraction 287 may be washed with a second round of warm water to extract more hemicellulose from the precipitate. Surprisingly, it was discovered that the temperature and cooling of the water used for solubilization of the hemicellulose and separation of the lignin from the precipitate is of critical importance. Heating the hemicellulose and lignin precipitate with water to 95° C. then cooling to 60° C. allowed the lignin to coalesce into larger particles which are much easier to filter and wash. In contrast, heating to 120° C. actually caused the lignin to form a solid mass which caused problems with handling and recovery of hemicellulose.

In the overall embodiment depicted in FIG. 2 the C₁-C₂ acid (acetic acid) and the C₁-C₂ acid-miscible organic solvent (ethyl acetate) is recovered from the process and recycled for continued use. Thus for example, the recovered ethyl acetate filtrate 278 is evaporated at step 290 to recover the ethyl acetate, leaving behind a dark residue 291. At step 295 the ethyl acetate and acetic acid recovered by evaporation at step 290 is combined with the acetic acid/ethyl acetate filtrate 261 and the acetic acid recovered from evaporation of the hydrolysate at step 250. These combined materials are then separated by distillation at step 298 to recover the acetic acid away from the ethyl acetate.

Almost all of the acetic used in the process depicted in FIG. 2 is utilized in streams that can be readily separated by simple distillation from the C₁-C₂ acid-miscible organic solvent rather than water. The combination of acetic acid and ethyl acetate were particularly effective. The C₁-C₂ acid-miscible solvents used in the process are chosen for their ability to precipitate both lignin and oligosaccharides as well as some monosaccharides from the acetic acid. They also are easily separated from the acetic acid by simple distillation. The processes of the prior art where acetic acid or formic acid are used in combination with water to separate hemicellulose and lignin from cellulose pulp suffer from the disadvantage of creating water acid azeotrope mixtures that are more difficult to recover and recycle for continued use. The processes of the present invention rely principally on the combination of the acetic acid with a miscible organic solvent.

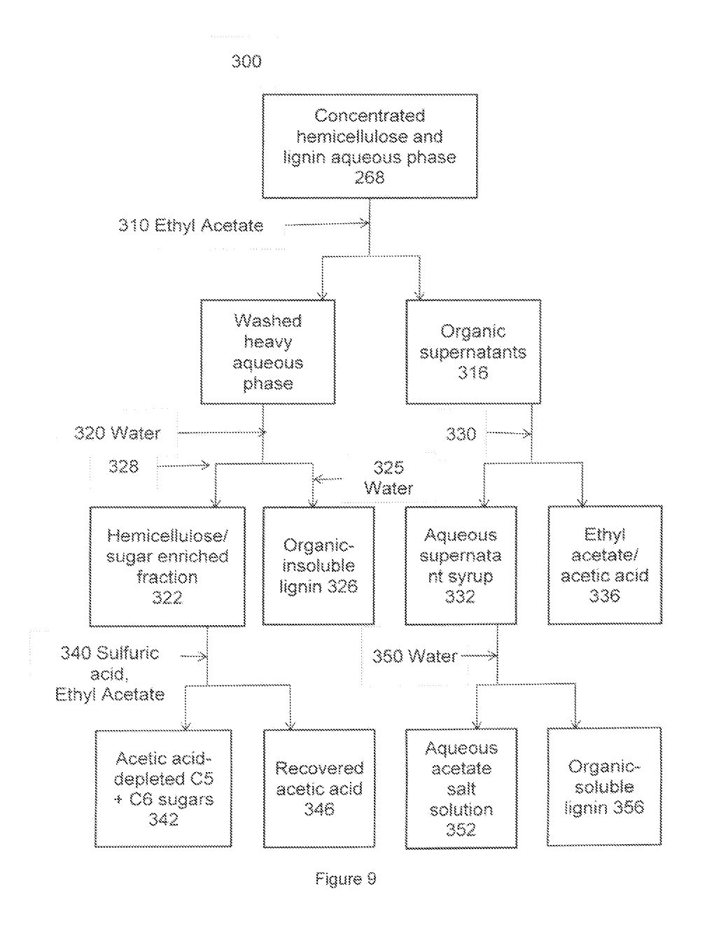

FIG. 9 illustrates a second preferred process for further processing the Concentrated hemicellulose and lignin aqueous phase 268 of the invention pertaining to separation and recovery of C5 and C6 sugars, organic-soluble lignin, organic-insoluble lignin, and acetate salts from a lignocellulosic biomass, particularly when acetic acid is used as the C₁-C₂ acid. In an exemplary embodiment of the second preferred process, corn stover containing 8% moisture was hydrolyzed at 163-171° C. for 10 minutes in a rotary reactor with ˜70% acetic acid solution. The reactor was cooled and the hydrolyzed stover was pressed and filtered to provide the first hydrolyzate 207 (FIG. 2) and the acetylated lignocellulose cake 208. The acetylated lignocellulose cake 208 was contacted with a second amount of acetic acid at 60° C. and filtered to yield the acid washed acylated lignocellulose cake 214, and the acid wash 212. The acid washed acetyl cellulose cake 214 was contacted twice with ethyl acetate and filtered to produce an ethyl acetate washed acetyl cellulose pulp 218 and ethyl acetate wash 216. The first acid hydrolyzate was combined with the acid wash to form combined acetic solubles 209. Acetic acid was recovered from the combined acetic solubles by evaporation, forming Evaporate (concentrate) 221. This was combined with the ethyl acetate wash 216 to form Ethyl Acetate: Acetic acid 50:50 mixture 257. Ethyl acetate was recovered by evaporation 265, forming the concentrated hemicellulose and lignin aqueous phase 268 enriched with hemicellulose and lignin.

In the second preferred embodiment 300 shown in FIG. 9 to effect separation of the concentrated hemicellulose and lignin aqueous phase 268 by liquid/liquid separation, the concentrated hemicellulose and lignin aqueous phase 268 was contacted with the first amount of ethyl acetate 310 such that 5 to 7.5 parts by volume of ethyl acetate or other C₁-C₂ acid-miscible organic solvent was added to 5 parts by volume of the concentrated hemicellulose and lignin aqueous phase 268 to remove the acetic acid by liquid/liquid separation. Surprisingly, it was discovered that at these ratios of C₁-C₂ acid-miscible organic solvent to concentrated hemicellulose and lignin aqueous phase 268, a phase separation took place without formation of a precipitate. Further, it was discovered that the amount of C₁-C₂ acid-miscible organic solvent is of critical importance in causing a phase separation and preventing formation of a precipitate. For the concentrated hemicellulose and lignin aqueous phase 268, a ratio of 1 to 1.5 parts by volume of ethyl acetate to 1 part by volume of aqueous concentrated hemicellulose and lignin aqueous phase 268 was sufficient to induce phase separation without formation of a precipitate. Importantly, under these conditions much less solvent was used than for the first embodiment depicted in FIG. 2. Using a smaller amount of C₁-C₂ acid-miscible organic solvent for acetic acid extraction not only resulted in liquid/liquid separation, it reduced the expense of subsequent solvent recovery due to the smaller volume of solvent used.

The mixture rapidly separated into two phases: a gummy heavy aqueous phase containing most of the sugars and the organic-insoluble lignin (about half of the lignin); and an organic supernatant phase containing the organic-soluble lignin, the acetate salts fraction, ethyl acetate and acetic acid. The organic supernatant phase was decanted from a heavy aqueous phase. The heavy aqueous phase (one part) was contacted (washed) with ethyl acetate or other C₁-C₂ acid-miscible organic solvent (about one part) and mixed at 50° C. The mixture separated again, forming a second organic supernatant over the heavy aqueous phase; the second supernatant was decanted. Ethyl acetate (about one part) was again contacted with the heavy aqueous phase with mixing at 50° C. The mixture separated again, forming a third organic supernatant and a first phase comprising a washed heavy phase aqueous 312. The third organic supernatant was decanted. Finally, the washed heavy aqueous phase 312 contained most of the C5 and C6 sugars and about half of the lignin and was depleted in acetic acid. The solvent-rich organic supernatants phase contained organic soluble lignins, acetate salts, the acetic acid and ethyl acetate. Optionally, the washed heavy phase aqueous 312 may be washed with further quantities of the C₁-C₂ acid-miscible organic solvent to remove residual acetic acid. Almost all of the acetic acid used in the process depicted in FIG. 9 was utilized in streams that can be readily separated by simple distillation from the C₁-C₂ acid-miscible organic solvent rather than water. The combination of acetic acid and ethyl acetate was particularly effective. The C₁-C₂ acid-miscible solvent used in the process was chosen for the ability to induce a phase separation. A substantial economic gain can be realized by the partitioning of ethyl acetate and acetic acid away from the sugar-rich aqueous phase.

Still with reference to FIG. 9, the organic supernatants were combined and mixed to form the organic supernatants phase (second phase) 316; a small amount of tarry precipitate formed, which was separated and added to the washed heavy aqueous phase 312. The acetic acid partitioned with the ethyl acetate into the organic supernatants, resulting in a decrease in the amount of acetic acid in the sugar- and lignin-containing washed heavy aqueous phase 312 (first phase).

Fractionation of lignin. The phase separation into a first phase (washed heavy aqueous phase) and a second phase (organic supernatants phase) results in a fractionation of the lignin into organic-soluble lignin and organic-insoluble lignin fractions. The fractionation of corn stover lignin into organic-soluble lignin and organic-insoluble lignin yielded lignin fractions that can each be expected to have certain properties based on the corn stover. Because lignin is a heterogeneous polymer lacking a defined primary structure, characterization of lignins is based on properties or source instead of structure. The present process does not use sulfuric acid, thus the lignin fractions which are produced are sulfur-free. Similar process steps can be applied to lignins from other sources. The properties of organic-soluble lignin and organic-insoluble lignin from each source, as well as relative quantities and linkages of p-hydroxyphenyl alcohol, guaiacyl alcohol, and syringyl alcohol, can be expected to have certain properties based on, and perhaps unique to, the lignin source. Sources for lignin include softwood lignins from conifers such as spruce, cedar, pine, and redwood; hardwood lignins, such as lignins from maple, poplar, oak, eucalyptus, and basswood; stalk lignins, such as lignins from straw, maize, canola, oat, rice, broomcorn, wheat, soy, barley, spelt, and cotton; grass lignins from grasses such as bamboo, miscanthus, sugar cane, switchgrass, reed canary grass, cord grass.

Recovery of organic-insoluble lignin. Contacting the washed heavy aqueous phase (first phase) with water induced coagulation of lignin wherein a phase enriched in C5 and C6 sugars (soluble hemicellulose phase) separated from coagulated organic-insoluble lignin. The washed heavy aqueous phase 312 (1 part) was contacted with water 320 (2 parts), whereupon a fluffy precipitate of organic-insoluble lignin formed. The mixture was allowed to settle, whereupon a clear brown liquid (about 2.5 parts) and a precipitate (about 0.4 parts) were observed. The upper phase may be decanted and the precipitate washed with 0.6 parts of water. The precipitate may be filtered and the wash water combined with the clear brown liquid. In a preferred practice, after the step of contacting the washed heavy aqueous phase 312 (1 part) with water 320 (2 parts), the mixture was heated to 95° C. with mixing, facilitating coagulation of the precipitated lignin. The mixture was allowed to cool to 50° C. under mixing, and then filtered 328. The temperature and cooling of the water used for solubilization of the hemicellulose and separation of the lignin from the precipitate are of critical importance. Heating the hemicellulose and lignin precipitate with water to 95° C. then cooling to 50° C. allowed the lignin to coalesce into larger particles which were much easier to filter and wash than the fluffy precipitate of organic-insoluble lignin that formed when the washed heavy aqueous phase 312 (1 part) was contacted with water 320 (2 parts). After the filtration step 328, a hemicellulose/sugar enriched fraction 322 (3.3 parts) and a lignin cake were obtained. The lignin cake was washed with 0.8 parts of water 325 and dried to yield organic-insoluble lignin 326.

Recovery of C5 and C6 monosaccharides and acetic acid Some of the small amount of acetic acid in hemicellulose/sugar enriched fraction 322 was present in the form of acetate salts. The acetate salts in the hemicellulose/sugar enriched fraction 322 were converted to free acetic acid by adding sulfuric acid to the hemicellulose/sugar enriched fraction 322 to convert acetate salts to free acetic acid. The mixture was then contacted with an equal volume of acetic-miscible organic solvent (ethyl acetate) in step 340. Two liquid phases formed and easily separated without emulsion formation. An aqueous phase comprising acetic acid-depleted C5+C6 sugars 342 (third phase) formed, and an organic phase comprising the ethyl acetate with recovered acetic acid 346 (fourth phase) formed. In the presence of large amounts of water, this phase separation would be impractical due to the formation of emulsion. The acetic acid-depleted C5+C6 sugar phase 342 may be re-extracted with ethyl acetate. The acetic acid-depleted C5+C6 sugar phase 342 was in the form of a thermoplastic pellet which is enriched in C5 and C6 sugars and was suitable for fermentation, such as SHF. The acetic acid and ethyl acetate in 346 can be easily recovered separately for recycling into the process.

Separation of second phase comprising organic supernatants. The second phase comprising organic supernatants 316 was subjected to evaporation 330 to recover C₁-C₂ acid-miscible organic solvent and acetic acid in a stream 336 separate from an aqueous phase comprising an aqueous supernatant syrup 332. The acetic acid and the C₁-C₂ acid-miscible organic solvent are recovered from the process and recycled for continued use as outlined in the overall embodiment depicted in FIG. 2. The C₁-C₂ acid-miscible solvent was easily separated from the acetic acid by simple distillation. The processes of the prior art where acetic acid or formic acid are used in combination with water to separate hemicellulose and lignin from cellulose pulp suffer from the disadvantage of creating water-acid azeotrope mixtures that are much more difficult and expensive to recover and recycle for continued use. The processes of the present invention rely principally on the combination of acetic acid with a C₁-C₂ acid-miscible organic solvent, obviating water azeotropes and facilitating much more economical recovery and recycle of both the acid and the solvent.

Aqueous supernatant syrup 332 (one part) was contacted with water 350 (one part) to induce phase separation to form the fifth phase comprising the aqueous phase enriched in acetate salts and reduced in content of organic-soluble lignin 352 and the sixth phase comprising a phase enriched in organic-soluble lignin 356. The two-phase mixture was heated to 90° C. with stirring to evaporate ethyl acetate. The heating also promoted the extraction water-soluble components, such as acetate salts, into the aqueous fifth phase. The two phase mixture was cooled to 40° C., and the aqueous fifth phase 352 was removed and concentrated by evaporation to enrich the acetate salts, such as potassium acetate. In a preferred embodiment, the organic soluble lignin phase is contacted with water again and heated. In this embodiment, the water washes are combined with the aqueous fifth phase and evaporated. This aqueous phase may be dried and used for fertilizer. The water-washed organic-soluble lignin sixth phase was cooled, ground and dried to yield organic-insoluble lignin 356. A lignin fraction obtained by extraction with ethyl acetate was characterized as having a high radical scavenging index (RSI), potentially making this lignin useful as a stabilizing agent.

By conducting liquid/liquid separations in the manner described in this disclosure, chopped corn stover or other lignocellulosic biomass can be fractionated into products comprising acetic acid-depleted C5+C6 sugars 342, an organic-insoluble lignin 326, an organic-soluble lignin 356, and an aqueous acetate salt solution 352. In addition, emulsion formation was prevented, substantially reduced volumes of ethyl acetate were used, and both ethyl acetate and acetic acid were easily recovered. Almost all of the acetic acid used in the process depicted in FIG. 9 was utilized in streams that can be readily separated by simple distillation from the C1-C2 acid-miscible organic solvent rather than water.

The combination of acetic acid and ethyl acetate were particularly effective. The C1-C2 acid-miscible solvents used in the process are chosen for their ability to precipitate both lignin and oligosaccharides as well as some monosaccharides from the acetic acid, and for their ease of separation from acetic acid by simple distillation.

Compositional Analysis of the Soluble Hemicellulose Fraction. A sample of the soluble hemicellulose fraction 289 obtained by the foregoing method was subjected to detailed chemical analysis for monomeric sugar, acid hydrolyzable sugar, lignin and acetic acid content, as well as other elemental substituents (see Table 21, Example 1). Of the total carbohydrates in the form of acid hydrolyzable oligomers and monomeric sugars, about 19% were monomeric C5 and C6 sugars and about 81% were in the form of hydrolyzable oligomers ((hemicellulose oligomers). Together these accounted for about 68% of the total mass of the sample. The lignin content was only 0.28% of the mass. A small amount of acetic acid was retained through the process, accounting for about 1.2% of the mass. Most organisms used in fermentation to produce ethanol can tolerate up to 1% w/v acetic acid, but have a preference for concentrations well below 0.5% w/v at pH of around 6. If desired, the acetic acid content can be reduced by washing the hemicellulose/lignin precipitate 277 with ethyl acetate or other acetic acid miscible organic solvent prior to dissolving in water at step 280. In this case, it is preferable to use a less polar acetic acid miscible solvent, such as methyl ethyl ketone, propanol and the like so as to avoid removal of monomeric sugars from the soluble hemicellulose fraction 289.

From an exemplary practice of the forgoing, the mass distribution was as follows: From 1.5 kg of chopped corn stover at 92% solids content (1380 g starting solids material) about 810 grams was recovered in the ethyl acetated washed pulp 218, of which about 80% was in the form of cellulose and which also contained about 10% pentoses. The concentrated hemicellulose and lignin aqueous phase 268 was about 50% dissolved solids and contained about 10% sugars and 60% lignin. From that, about 525 g of the starting solids material was recovered in the hemicellulose lignin precipitate fraction 277, of which about 45% was in the form of hemicellulose 289 and the remainder in the form of lignin 287.

Compositional Analysis of the Cellulosic Pulp The cellulose and lignin content of the cellulose pulp 218 was analyzed by the ANKOM™ Fiber Analysis method (Vogel et al 1999) and the standard method defined by the National Renewable Energy Laboratory (NREL) Compositional analysis of lignocellulosic feedstocks. (Sluiter et al 2010). Analysis of several wet and dry fractions of the cellulose pulp 218 obtained from processing corn stover biomass 10 stover as described above is provided in Tables 1 and 2. The analysis by the ANKOM™ method (Table 1) indicates that cellulose represented 85.5 to 88.4% of the total dry matter with hemicellulose present in the range of 0.7-3.5% and lignin in the range of 1.0-2.3%. In samples treated with a combination of acetic and sulfuric acid, a higher concentration of cellulose was obtained with increased sulfuric while the hemicellulose is reduced, consistent with greater hydrolysis of hemicellulose. By comparison, the samples analyzed with the NREL method (Table 2), indicate the presence of a lower cellulose concentration in the range of 62.2-77.3%, while hemicellulose and lignin were higher by this method (3.2-15.8% and 1.0-5.8%). When the samples are treated with a combination of acetic acid and sulfuric, an increase in cellulose content with a parallel reduction in hemicellulose was also observed. While analyses by the ANKOM™ method indicated some variability in the pulp and a lower content in the overall cellulose composition when compared with the NREL method, material balance measurements indicated consistent accounting for the majority of the solids by both methods (range 94.1-108.8% with an average of 99.1%).

TABLE 1
Compositional Analysis of Cellulosic pulp 218 by ANKOM ™ Fiber Analysis Method

| | | Cellulose | Hemicellulose | Lignin |
|---|---|---|---|---|
| Sample | Description | % Dry Matter | % Dry Matter | % Dry Matter |
| Sample 1A | Wet Stover pulp Cake Sample A | 85.50 | 1.11 | 1.54 |
| Sample 1B | Wet Stover Cake Pulp Sample B Sa | 88.41 | 2.89 | 1.04 |
| Sample 1A.d | Dried Corn Stover Pulp Sample A | 85.33 | 3.53 | 1.87 |
| Sample 1B.d | Dried Corn Stover Pulp Sample B | 88.02 | 0.41 | 1.45 |
| Wet Cake .A | Wet Cake (70% AcOH w/0.25% H₂SO₄) | 85.27 | 2.50 | 2.30 |
| Wet Cake B | Wet Cake (50% AcOH w/0.5% H₂SO₄) | 87.91 | 0.71 | 1.83 |

TABLE 2
Compositional Analysis of Cellulosic Pulp 218 by the NREL Method

| | % | % | % | % | % | % | % | % | |
|---|---|---|---|---|---|---|---|---|---|
| Description | Ash | Protein | Lignin | Glucan | Xylan | Galactan | Arabinan | Acetate | Total % |
| Sample 1A.d | 6.45 | 1.75 | 4.56 | 78.85 | 12.64 | 0.68 | 0.78 | 3.09 | 108.80 |
| Sample 2 | 5.67 | 0.63 | 3.01 | 68.91 | 15.84 | 0.79 | 0.87 | 2.33 | 98.04 |
| Sample 3 | 8.16 | 1.19 | 2.74 | 72.11 | 10.11 | 0.71 | 0.61 | 2.65 | 98.27 |
| Sample 4 | 9.77 | 1.17 | 4.49 | 77.26 | 3.23 | 0.68 | 0.61 | 3.26 | 100.47 |
| Sample 5 | 8.14 | 2.73 | 0.95 | 71.64 | 10.77 | 0.60 | 0.50 | 2.64 | 97.96 |
| Sample 6 | 16.21 | 3.61 | 0.12 | 62.20 | 8.35 | 0.46 | 0.91 | 2.23 | 94.09 |
| Sample 7 | 11.58 | 0.81 | 3.74 | 71.50 | 6.43 | 0.52 | 0.62 | 2.44 | 97.64 |
| Sample 8 | 7.04 | 1.50 | 5.82 | 67.26 | 12.02 | 0.44 | 1.03 | 2.35 | 97.47 |

Treatment of the soluble hemicellulose 289 or the cellulose pulp 218 to make a C6 or C5 enriched syrup. The cellulose pulp 218 is primarily cellulose (62.2% to 88.4% by weight depending on method of analysis and sample analyzed), which when digested by a suitable cellulolytic enzyme cocktail should produce a syrup enriched with C6 sugars—primarily glucose. The solubilized hemicellulose enriched fraction 289 is a hemicellulose stream nearly devoid of lignin and is made up of a mixture of monomers and oligomers of xylose with traces of arabinose, glucose, and other hexose sugars. When fully digested by a suitable hemicellulolytic enzyme cocktail the soluble hemicellulose enriched fraction 289 should produce a syrup primarily enriched in C5 sugars. The terms “cellulolytic enzyme” and “hemicellulolytic enzyme” and cocktails thereof, means one or more (e.g., “several”) enzymes that hydrolyze a cellulose or hemicellulose containing material, respectively. Examples of such enzymes are provided in-pending U.S. provisional application No. 61/538,211 entitled Cellulolytic Enzyme Compositions and Uses Thereof It was discovered by the present applicants, however, that conventional cellulolytic and hemicellulolytic enzyme cocktails available for digestion of cellulose and hemicellulose, did not operate efficiently with the cellulose pulp and soluble hemicellulose fractions prepared by acetic acid treatment of corn stover as the lignocellulosic biomass. Initial results showed that the enzymatic hydrolysis of the solubilized C5 syrup and the C6 pulp proceeded slowly, even with high enzyme loading, and the amount of monosaccharides released was less than predicted.

Initial Hemicellulose 289 Hydrolysis. Enzyme hydrolysis of the soluble hemicellulose fraction 289 was carried out to convert the soluble hemicellulose oligomers to monomers for fermentation. Total carbohydrate analysis of this fraction by the phenol-sulfuric acid method indicated a total carbohydrate concentration of 65% w/w dry mass basis. The initial enzyme hydrolysis employed cocktails of commercial enzymes available from Novozymes A/S (Bagsvaard, Denmark) under the trade names Cellic CTec (cellulase(s)) and Viscozyme L (pectinase(s)) blended in a 4:1 ratio was used at an enzyme dose rate of 2% w/w dry basis of soluble hemicellulose 289 solids diluted to 10% wt/vol with 50 mM citrate buffer pH 5.0. Samples were incubated at 50° C. for five days. Results are provided in Table 3 below. These indicate a yield of 82.7% of monomers of the total carbohydrates after enzyme hydrolysis. Only about 80% of the total carbohydrates were in the form of acid hydrolyzable hemicellulose oligomers, so the percentage of hemicellulose oligomers converted to monomeric sugars was only about 65%.

TABLE 3
Results of Enzyme Hydrolysis of Hemicellulose from Corn Stover

| | Dextrose | Xylose | Arabinose |
|---|---|---|---|
| C5 Fraction | %, db | %, db | %, db |
| Enzyme | 13 | 37.4 | 3.4 |
| Hydrolyzed | | | |
| Control | 6.3 | 18.2 | 3.5 |

Initial Cellulose Pulp 218 Hydrolysis Enzymatic hydrolysis of the cellulose pulp 218 prepared as described above was also conducted. A cocktail of two commercial enzymes from Novozymes (Cellic CTec2 (cellulase(s)) Cellic HTec2 (xylanase(s)) were used for the enzyme hydrolysis of the cellulose pulp fraction. Other commercial and non-commercial enzyme blends were also tested. The cellulose pulp 218 analyzed by the ANKOM™ fiber analysis method averaged 86.7%, 1.8%, and 1.7% on a w/w dry basis cellulose, hemicellulose, and lignin, respectively, for six samples of cellulose pulp 218. Bench scale enzyme hydrolysis was carried out at both low solids (10%) and high solids loading (20%). Low solids enzyme hydrolysis produced 87.8% conversion of the cellulose pulp 218 to glucose and xylose, whereas, high solids enzyme hydrolysis experiments with 20% dry solids loading gave over 82.6% conversion to glucose and xylose (Table 4). Enzyme hydrolysis in both experiments was carried out at 50° C. for five days. The enzyme dose for low solids enzyme hydrolysis was 12 mg enzyme protein/g pulp dry solids. For high solids enzyme hydrolysis the dose was 33 mg enzyme protein/g pulp dry solids.

TABLE 4
Enzyme Hydrolysis of Cellulose Pulp 218
Obtained from Corn Stover at 10-20% Dry Solids

| | Initial | | | | Enzyme |
|---|---|---|---|---|---|
| | Dry | | | Acetic | Hydrolysate |
| | Solids | Dextrose | Xylose | acid | Dry Solids |
| | g/kg | g/kg | g/kg | g/kg | g/kg |
| 10% solids | 100 | 75.0 | 10.5 | 2.0 | 108 |
| 20% solids | 200 | 130.8 | 31.6 | 0.7 | 217.1 |

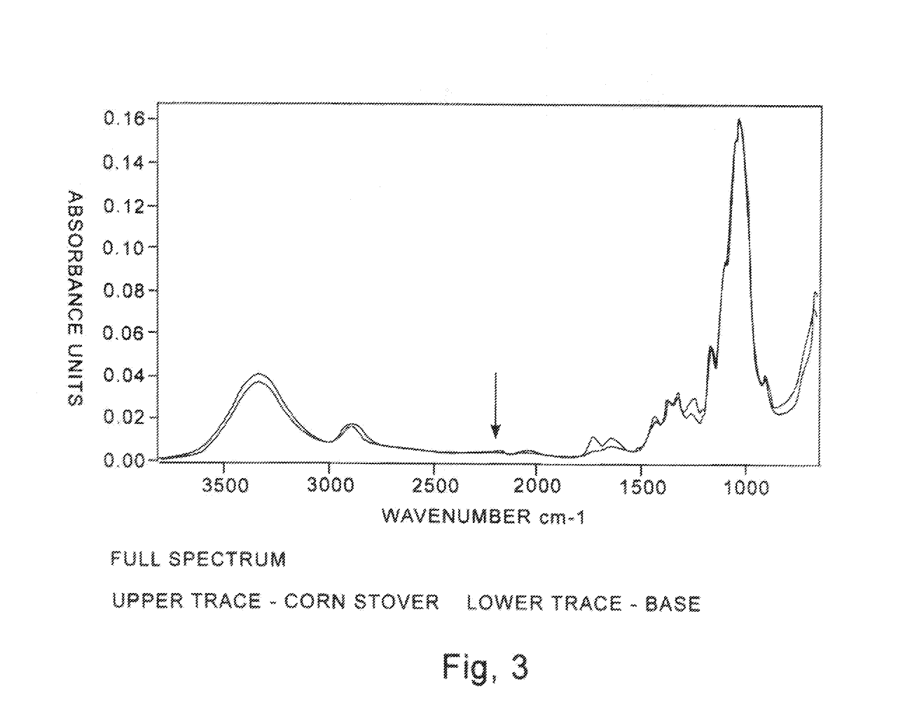

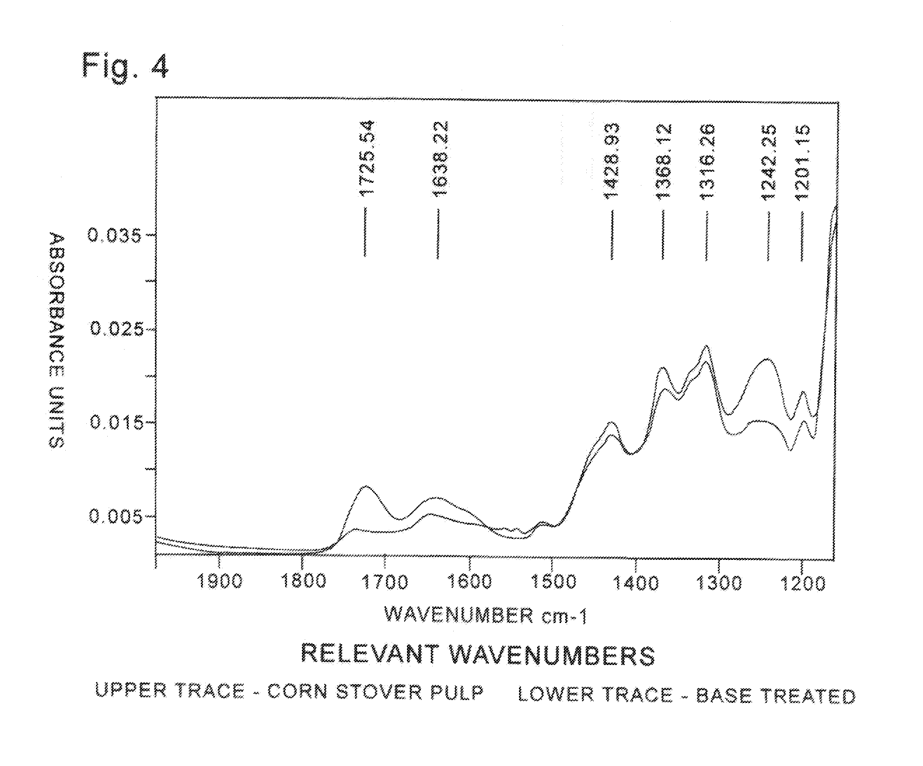

The foregoing results showed less conversion of the soluble hemicellulose fraction 289 and the cellulose pulp fraction 218 to monomeric sugars than is needed to make subsequent fermentation economically practical. These materials were made by exposure of the biomass to heat in the presence of high concentrations of acetic acid (>70%). It was speculated that some of the free and bound sugars may have become substituted with acetyl groups and that this acetylation may at least partially inhibit enzymatic activity. To test this, samples of the cellulose pulp 218 were treated with a base to catalyze deesterification of the acetate group. The result was assessed by Fourier Transform Infrared Spectroscopy (FTIR). FIG. 3 illustrates the difference in FTIR spectra of corn stover cellulose pulp (top trace) and ammonium hydroxide treated corn stover pulp (lower trace). FIG. 4 shows the FTIR spectra between 1150 cm⁻¹ and 2000 cm⁻¹, where three important ester bonds are represented by the C═O ester stretching at 1725 cm⁻¹, the C—H stretching in —O(C═O)—CH₃ group at 1366 cm⁻¹, and the —CO— stretching of acetyl group at 1242 cm⁻1 are indicated. The absence of a peak at 1700 cm⁻¹ representing the absorption of a carboxylic group confirmed that the alkaline treated sample is free of esterified acetic acid.

It was this result that indicated that acetic acid hydrolysis of lignocellulosic biomass 10 according to FIG. 2 resulted in a cellulose pulp 218 that was acetylated. More generally, treatment of a lignocellulosic biomass 10 by a C₁-C₂ acid results in a significant fraction of the cellulose pulp 218 as well as the soluble hemicellulose fraction 289 being acylated by the C₁-C₂ acid hydrolysis 210 and wash steps 220 (i.e., the carbohydrate fractions will contain formyl- or acetyl-esters). Hence, production of suitable feedstock C5 and C6 sugar syrups for fermentation by enzyme digestion requires deacylation of the esters prior to, or in conjunction with, digestion of the cellulose polymers or hemicellulose oligomers with the appropriate enzyme cocktails.

Formylated carbohydrate esters made when the C₁-C₂ acid is formic acid are heat labile. Accordingly, a formylated cellulose pulp 218 or soluble hemicellulose fraction 289 can be deformylated by incubation of the material in an aqueous solution at a temperature of 50° C. to 95° C. for 0.5 to 4 hours, which is sufficient to deformylate the carbohydrates as described for example in Chempolis, U.S. Pat. No. 6,252,109. Acetylated carbohydrates, however, are more stable than formylated esters. Acetyl esters can be deacetylated by treatment with an alkali (base). Suitable bases include ammonia (ammonium hydroxide) and caustic (sodium hydroxide). Accordingly, the cellulose pulp 218 and soluble hemicellulose fractions were treated by contact with alkaline bases prior to enzymatic digestions. Acetic acid treated corn stover pulp sample preparations 218 were diluted with water to form a mixture of 8% solid. NaOH was added to adjust the pH to 13. The mix was heated to boiling, and kept boiling for 10 min. Phosphoric acid was used to adjust the pH to 5.0 after the reaction mix reached room temperature. A control cellulose pulp 218 was heated similarly at the same time and at the same solid content without sodium hydroxide treatment or pH adjustment. The alkali treated samples were adjusted to a 5% dissolved solids mixture and analyzed for acetic acid with the results shown in Table 5.

TABLE 5
Release of Acetic Acid from Cellulose Pulp 218 by Base

| | acetic acid (mg/g) |
|---|---|
| NaOH treated | 1.68 |
| Control | 0.75 |

The results indicated that more acetic acid was freed by the alkaline treatment as compared with the untreated control. The acetic acid that was freed by the heated alkaline treatment provided additional confirmation that acetyl groups are covalently linked to carbohydrate pulp fiber molecules via ester links formed during the acetic acid treatment steps. The degree of esterification in various cellulose pulp 218 fractions made by the processes described herein ranged from a 0.05 to 0.2 degree of substitution (i.e., 5%-20% of the sugar residues are acetylated) which corresponds to 1.4% to 6.6% w/w acetyl content of the mass of the cellulose pulp fraction.

To confirm whether the deesterification would improve enzyme digestibility the treated cellulose pulp 218 samples prepared above were subjected to enzyme hydrolysis at 5% solids content with citrate buffer and a commercial cellulase enzyme blend from Novozymes (Cellic Ctec). Enzyme treatments were carried out in a rotisserie incubator (Daigger FinePCR Combi D24) at 50° C. for 96 hrs. The enzyme treated samples were analyzed for sugars by HPLC. Table 6 provides a summary of analytical results.

TABLE 6
Impact of Base Treatment on Enzymatic Release
of Glucose from Corn Stover Cellulose Pulp 218

| Content mg/g | Glucose | Xylose |
|---|---|---|
| NaOH treated | 12.8 | 4.0 |
| Control | 6.1 | 3.0 |

The results indicated that enzyme treatment of alkaline de-esterified cellulose pulp 218, results in a substantially higher release of glucose and xylose. The results further supported the finding that acetate esters hindered enzyme access to cellulose in the aforementioned enzymatic digestions using different mixtures of cellulolytic and hemicellulolytic enzymes. Presumably by removing the acetate esters, the enzymes can access and bind the substrate better and therefore, hydrolyze more cellulose pulp 218 and hemicellulose 289 fiber polymers, resulting in release of more glucose and other monomeric sugars. The results also indicate that heating 10 to 30 minutes in an autoclave at 121° C., with ammonia at a concentration of 0.1% to 1%, or at the lower temperature of 50° C. for 1 to 10 hr, with ammonia 0.5 to 5% is sufficient to release most acetyl groups from the pulp.

Detergents It was further discovered that non-ionic detergents can substantially increase the activity of hemicellulolytic and cellulolytic enzyme preparations. Cellulose pulp samples 218 were treated with alkaline NaOH followed by treatment with a commercial enzyme cellulase blend. Many detergent chemicals, including Tween-20 (polyoxyethylene sorbitan monolaurate), Tween-40 (polyoxyethylene sorbitan monopalmitate), Tween-60 (polyoxyethylene sorbitan monostearate) and triton X-100 (4-octylphenol polyethoxylate) were tested to determine their function on enzyme hydrolysis of the pulp. The enzyme reaction contained 5% pulp solids wt/wt of a 50 mM citrate buffer, the commercial cellulase enzyme blend Cellic Ctec II, with or without detergents, for example, Tween-40 at 0.2% w/w content. After 6 days, the resulting mixtures were analyzed for glucose by HPLC.

TABLE 7
Impact of Tween 40 on Release
of Glucose from Cellulose Pulp 218

| Additive | glucose (mg/ml) |
|---|---|
| Tween-40 Supplementation | 38 |
| Control without addition | 20 |

In another test, cellulosic pulp 218 from acetic acid treated corn stover prepared as described herein but not deacetylated by base treatment was dried and treated with Novozymes' cellulase blend Cellic CTec2, Novozymes pectinase Viscozyme L or xylanase Htec2 hemicellulase blends, at high and low enzyme doses, with or without Tween 40. The results provided in Table 8, indicate that Viscozyme consistently released more sugar than HTec2, and importantly, that including Tween 40 in the treatment step, resulted in a higher release of sugar event when the cellulose pulp 218 was not deacetylated. The results also indicated that high enzyme dose can at least partially overcome inhibition of the cellulases by acetylation of the cellulosic pulp during pretreatment. This further suggest that the tested cellulase enzyme blends have a low level of esterase activity that is present and that including more esterase activity in the blend can be useful in reducing cellulase enzyme loading.

TABLE 8
Improved Glucose Release from Cellulose Pulp With Cellulases/Tween 40

| Sample | Tween 40 | Total Enz | | Dextrose (g/L) by HPLC | | | | | |
|---|---|---|---|---|---|---|---|---|---|
| ID | (0.02% w/w) | (%, v/db) | Enz 2 | Day 3 | Day 6 | Day 9 | Day 13 | Day 16 | Day 20 |
| 1 | Yes | 4.5 | Viscozyme | NL | NL | NL | 109.0 | 121.2 | 128.4 |
| | | | L | | | | | | |
| 2 | No | 4.5 | Viscozyme | NL | NL | NL | NL | NL | NL |
| | | | L | | | | | | |
| 3 | Yes | 4.5 | Htec2 | NL | NL | NL | NL | 103.7 | 119.6 |
| 4 | No | 4.5 | Htec2 | NL | NL | NL | NL | NL | NL |
| 5 | Yes | 25 | Viscozyme | NL | 147.0 | 153.0 | 153.1 | NS | NS |
| | | | L | | | | | | |
| 6 | No | 25 | Viscozyme | NL | 115.1 | 129.0 | 124.3 | NS | NS |
| | | | L | | | | | | |
| 7 | Yes | 25 | Htec2 | NL | 133.6 | 149.5 | 152.7 | NS | NS |
| 8 | No | 25 | Htec2 | NL | 107.0 | 121.3 | 129.2 | NS | NS |

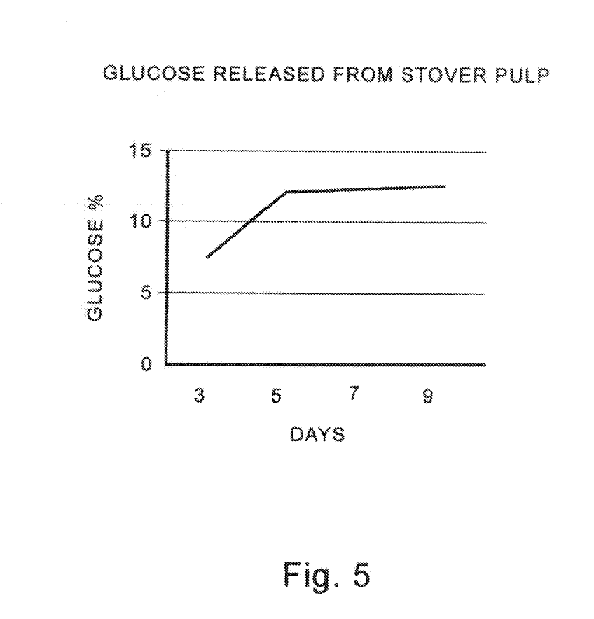

In another test the acetylated cellulose pulp 218 obtained after ethyl acetate washing was washed extensively with water after filtration to remove any free acetic acid. To the washed sample, NR₄OH was added to a final concentration of 0.5% (v/w). The samples were treated at 121° C. for 30 min to deacetylate the sample. Phosphoric acid, buffer and commercial enzymes (dosed at 3% of the DS) and Tween-40 (added to 0.5% w/v) were added to the base treated samples to make a 15% solids reaction mix. The samples were placed in a 50° C. incubator and rotated at 20 rpm. After 2 days of incubation, the cellulose pulp 215 started to liquefy. On the third day, the glucose content was measured. Additional samples were removed daily afterwards to check for glucose. The glucose released by the enzyme reaction is graphed in FIG. 5. After 7 days of incubation at 50° C., most of the glucose estimated to be present in the cellulose pulp 218 was released. The composition of the hydrolysate after 9 days was (on a w/w (Dissolved Materials basis) glucose 12.56% (84% DM), xylose 1.73% (11.5% DM), ash 2.0% (13.3% DM), and acetic 0.56% (3.7% DM).

Aliquots of the 9-day enzyme treated hydrolysate, were fermented by different yeast strains at 30° C. in stoppered shaker flasks rotated at 150 rpm. The culture was inoculated at a pitching rate of 250 million cells/ml. Samples were taken during fermentation at 24 hr and 48 hr. These samples were analyzed for sugars, organic acids and ethanol. The results indicate that one of the strains of yeast tested that was engineered to utilize xylose for fermentation (namely S. cerevisiae 424a, available from Purdue Research Foundation, Lafayette, Ind.) produced 5.6% ethanol (v/v) in 24 hr and used 50% of xylose within 48 hr.

The results summarized in Tables 7 and 8 indicate that the addition of detergent to a variety of cellulolytic and hemicellulolytic enzyme reactions results in a substantially greater release of glucose as compared with the control treated sample without the addition of Tween 40. Other non-ionic detergents that may also be suitable for enhancing the enzymatic activity of cellulolytic and hemicellulolytic enzyme preparations include, but are not limited to Tween-20, Tween-60, Tween-80 and Triton X-100. The amount of detergent to use should range from 0.01% and 5% v/wt of the reaction mix.

Incorporation of Esterases Although as described herein above, base catalyzed deesterification of the acylated cellulose pulp 218 and hemicellulose fractions 289 improves enzyme digestibility, it requires extra materials and produces a basic reaction mixture that must be pH adjusted before enzymatic digestion of the cellulose pulp 218 and soluble hemicellulose 289 fractions. It was surprisingly discovered, however, that these fractions can also be efficiently deacetylated by co-treatment with an esterase enzyme. This discovery was based in part on analysis of released acetic acid when a cellulose pulp 218 was treated with a cocktail of commercial hemicellulases and cellulases from Novozymes (Cellic CTec2 and HTec2). Such enzyme preparations are not highly purified to obtain one protein with one specific type of enzymatic activity but rather are cocktails of various partially purified enzyme activities that contain residual activities of other enzymes that co-purify in the preparation process. At high enzyme loading, some de-acetylation of the cellulose pulp 218 was observed consistent with a low level of esterase enzyme type activity being present in the enzyme blend. This formed the basis of seeking to incorporate more esterase activity by adding additional esterase activities preparations to cocktails of cellulolytic and hemicellulolytic enzyme preparations.

A suitable esterase for making the C6 and C5 syrups made from C₁-C₂ acid treatment of the cellulose pulp and hemicellulose fractions made as described herein should display at least one activity that catalyzes the hydrolysis of acetyl groups from at least one of: a polymeric xylan, acetylated xylose, acetylated glucose, acetylated cellulose, and acetylated arabionose. Co-pending U.S. patent application No. 61/538,211 entitled Cellulolytic Enzyme Compositions and Uses Thereof describes at least one example of such an esterase denoted acetylxylan esterase (AXE) that can be used to accomplish improved digestion of the cellulosic pulp 218 and soluble hemicellulose fractions 289 made as described herein to provide improved C6 and C5 syrups. AXE is a carboxylxylesterase (EC. 3.1.1.72) that catalyzes the hydrolysis of acetyl groups from polymeric xylan, acetylated xylose, acetylated glucose, alpha-naphthyl acetate and p-nitrophenylacetate. Its activity is measured by deacetylation of p-nitrophenylacetate in acetate buffer at pH 5.0, which provides the colorimetric product p-nitrophenolate. One unit of AXE is defined the amount of enzyme that releases 1 μmole of p-nitrophenolate per minute at 25° C. Co-pending U.S. patent application No. 61/538,211 entitled Cellulolytic Enzyme Compositions and Uses Thereof provides further data demonstrating that incorporation of such an esterase activity for digestion of the pulp 218 and soluble hemicellulose fractions 289 described herein improves conversion of the material to C6 and C5 syrups.

Fermentations The preparations of soluble hemicellulose 289 and the hemicellulose and lignin depleted cellulose pulp 218 materials made according to the processes described herein are used to make C5 and C6 sugars suitable as feedstocks for microorganisms employed to make a variety of products by fermentation. A variety of protocols for utilization such materials are possible, depending on the organism employed and the fermentation product being made. Most microorganisms can utilize the palette of C5 and C6 sugars made by digestion of these materials as a carbon source for cell growth (biomass accumulation). Biomass accumulation, however, is only one factor pertinent to the economics of production of the final fermentation product. For example, while a variety of yeast can utilize C5 sugars for biomass accumulation under aerobic growth conditions, most yeast do not produce ethanol by fermentation under such conditions. Conversely, under anaerobic conditions where yeast do produce ethanol from glucose and other C6 sugars, Saccharomyces yeast do not have the metabolic pathways necessary to divert the C5 sugars D-xylose and L-arabinose into ethanol production, unless they have been genetically engineered with exogenous enzyme activities to divert the C5 sugars into to the glycolytic pathway. In contrast, genetically engineered strains of the bacterium Zymomonas mobilis have the capacity to produce ethanol by fermentation on either C5 or C6 sugars under anaerobic conditions. Still Zymomonas, like yeast and most other microorganisms show a preference for the uptake of glucose first before the uptake of other C6 or C5 sugars.

Several variations for digestion and fermentation of the C5 and C6 sugars produced form the hemicellulose 289 and cellulose pulp 218 made by the methods provided herein. In one embodiment, the hemicellulose 289 and cellulose pulp 218 are first separately digested with enzymes to form separate C5 and C6 sugars. Subsequently, these feedstocks are fed to the microorganism to produce the fermentation product. When enzymatic digestion is conducted separately from subsequent fermentation to create a syrup, this is referred to as separate hydrolysis and fermentation with the abbreviation SHF.

In a SHF process the hemicellulose fraction 289 made by the processes of the invention is digested with appropriate enzyme cocktail containing cellulase, hemicellulase, pectinase, esterase and optionally or protease activities at temperatures of up to 70° C. and pH of 4.0-6.0 with continuous mixing to yield a C5 enriched sugar syrup. In the preferred embodiment, the enzyme digestions of the hemicellulose fraction 289 are carried out at 50-65° C. at a pH of 5.0 for 1 to 7 days. To yield the greatest amount of sugars, the enzyme digestion reaction mixtures also contain a non-ionic detergent such as Tween 40 as discussed herein above. Using the detergent allows the solids content of the cellulose pulp 218 or soluble hemicellulose fraction to be in range of 10%-25% w/w. The C5 sugar syrup resulting from the digestions is then either directly used as a feedstock in the fermentation media to either accumulate biomass, or to accumulate biomass and produce the desired fermentation product.

Similarly, the cellulose pulp 218 made as described herein can be subjected to enzyme digestion after suspending in an aqueous buffer solution at a pH of 4.5-5.5 at 10-25% dry solids using a cellulase blend of enzymes including an esterase at a temperature of 50° C. for 5 days to yield a fermentation feedstock comprised of the C6 sugar enriched syrup. Again, a non-ionic detergent such as Tween 40 is included in the digestion mixture which permits use of the high solids content of 10-25% cellulose pulp to maximize the yield of the C6 sugars.

If the desired fermentation product is ethanol and the fermenting microorganism is an ordinary industrial strain of the yeast S. cerevisiae, the yeast is grown on the C5 sugar syrup alone under aerobic conditions for a time sufficient to accumulate biomass in a first stage. In a second stage, the fermentation broth is fed with a C6 sugar source, preferably glucose, or sucrose, or mixtures of the same, and the fermentation is conducted under anaerobic conditions for a time sufficient to accumulate ethanol. The C6 sugar source may totally consist of the C6 syrup prepared from the cellulose pulp 218 as described herein.

If the desired fermentation product is ethanol and the fermenting microorganism is a genetically engineered strain of S. cerevisiae, the yeast is grown on the C5 sugar syrup alone under anaerobic conditions for a time sufficient to accumulate biomass and first portion of ethanol in a first stage. In a second stage, the fermentation broth is supplemented with a C6 sugar source, preferably glucose, or sucrose, or mixtures of the same, and the fermentation is continued under anaerobic conditions for a time sufficient to accumulate a second portion of ethanol. The C6 sugar source may include the C6 syrup prepared from the cellulose pulp 218 as described herein.

A SHF process to ferment ethanol was done using the C6 syrup obtained from digesting the cellulose pulp 218 at high enzyme high solids (20%) described in Table 4 above. A number of commercial and non-commercial strains were tested including xylose engineered recombinant strains of S. cerevisiae capable of fermenting C5 sugars to make ethanol. The strains tested include an in-house Saccharomyces cerevisiae production strain Y500 (Archer Daniels Midland Company, Decatur, Ill.) an in-house engineered strain capable of D-xylose fermentation designated 134-12 that is derived from Y-500, a commercial strain obtained from the Fermentis division of the LeSaffre Group (Milwaukee, Wis.) designated ER2, and a GMO strain of Saccharomyces cerevisiae engineered for xylose fermentation by Nancy Ho of Purdue University (Purdue Research Foundation, West Lafayette, Ind.) that is designated 424a. For the initial bench scale experiments, separate saccharification and fermentation trials were run to determine fermentation capacity using the xylose engineered recombinant strain 424a, which was described in Sedlak et al Enz. Microbial Technol. 33, 19-28 (2003). Table 9 shows the consumption of glucose (dextrose) and xylose and concomitant production of 8.5% v/v yield of ethanol in a 48 hour period using C6 and C5 syrups from deacetylated corn stover pulp.

TABLE 9
Production of Ethanol from C6 Syrup from Acetic
Acid treated Cellulose Pulp 218

| | | | Lactic | | Acetic | |
|---|---|---|---|---|---|---|
| Time | Dextrose | Xylose | acid | Glycerol | acid | Ethanol |
| hours | g/L | g/L | g/L | g/L | g/L | %, v/v |
| 0 | 146.9 | 25.9 | 0 | 12 | 1.0 | 0 |
| 24 | 0.5 | 11.3 | 0 | 13.5 | 1.2 | 6.3 |
| 42 | 0 | 9.4 | 0 | 17.8 | 2.6 | 8.5 |

Nearly all of the dextrose and 56% of the xylose was consumed in the first 24 hours.

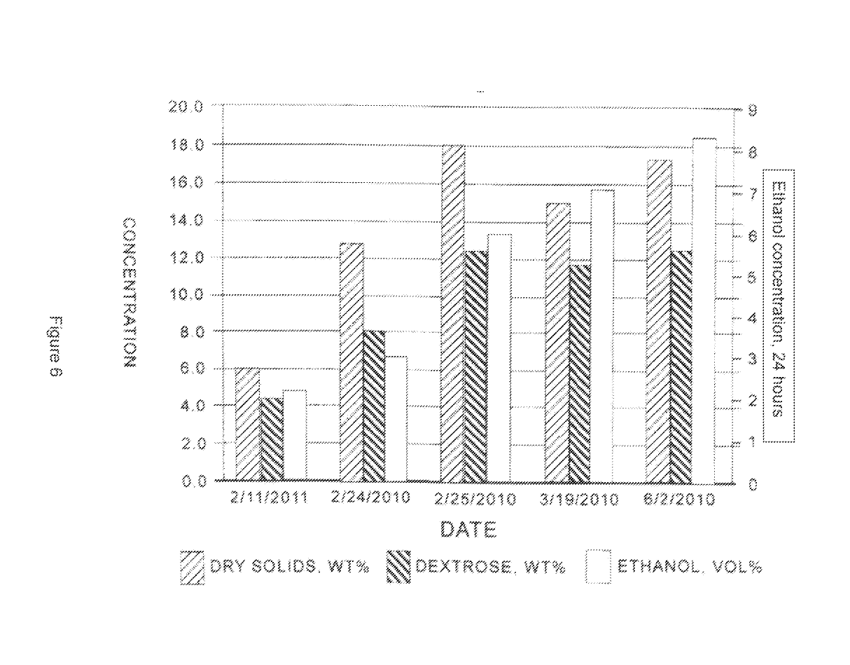

Further studies of SHF processes to ferment ethanol were carried out using the C6 syrup obtained from digesting the corn stover cellulose pulp 218 to produce an ethanol solution that will be economical to recover by distillation. Economical distillation is normally attained with at least 6.5% ethanol, which suggests that sugar solutions needed to attain this concentration need to be around 10%. Sugar solutions from enzyme hydrolysis at 10% by weight further suggest that enzyme hydrolysis must be carried out at high solids loading, between 15-20% by weight. High solids enzyme hydrolysis presents several problems, such as inadequate mixing, heat transfer and high viscosities. Several strategies were attempted to produce a concentrated sugar solution from enzyme hydrolysis, including low solids enzyme hydrolysis coupled to evaporative concentration, processive addition of solids during low solids enzyme hydrolysis and ultimately high solids enzyme hydrolysis with surfactant addition. Initial experiments resulted in 2.2% v/v ethanol from the fermentation of low solids (6%) enzyme hydrolysis of cellulose pulp 218 with two-fold evaporative concentration. (Table 10) Subsequent experiments produced 3% v/v ethanol from the fermentation of material produced by the enzyme hydrolysis of 9% solids cellulose pulp 218 with addition of cellulose pulp 218 to 14% total solids after solubilization of the initial solids. (Table 11) Ethanol was produced at 6% v/v concentration from material that was evaporatively concentrated two fold from enzyme hydrolysis of 9% solids cellulose pulp 218. (Table 12) Evaporative concentration adds an expensive step to commercial production of ethanol, so the alternative of high solids enzyme hydrolysis of cellulose pulp 218 with surfactant addition was tested. Several yeast strains produced ethanol from 6.8-7.1% v/v during shake flask fermentation of high solids enzyme hydrolysis of 16.5% solids cellulose pulp 218 with surfactant addition. (Table 13) Finally, material produced by high solids enzyme hydrolysis at 20% solids cellulose pulp 218 with surfactant addition was fermented in shake flasks by yeast strain 424a and produced 8.3% v/v ethanol. (Table 14) A graphical summary of the data, including pulp dry solids, sugar concentration and ethanol concentration produced, from Tables 10-14 is presented in FIG. 6.

TABLE 10
Shake Flask Fermentation of C6 Syrup 6% Dry Solids and Concentrated 2X

| | Halogen Dry | | | | | Lactic | | Acetic | |
|---|---|---|---|---|---|---|---|---|---|
| Time | Solids | DP3 | DP2 | Dextrose | Xylose | acid | Glycerol | acid | Ethanol |
| hours | %, w/w | g/L | g/L | g/L | g/L | g/L | g/L | g/L | %, v/v |
| 0 | 14.5 | 0.70 | 3.44 | 43.60 | 5.75 | 0.32 | 1.70 | 0.74 | 0.13 |
| 6 | na | 0.84 | 2.32 | nd | 4.52 | 0.44 | 4.11 | 1.38 | 2.20 |

TABLE 11
Shake Flask Fermentation of C6 Syrup
9% Dry Solids, with Sequential Increase of 5% Dry Solids

| | Oven Dry | | | | | Lactic | | Acetic | |
|---|---|---|---|---|---|---|---|---|---|
| Time | Solids | DP3 | DP2 | Dextrose | Xylose | acid | Glycerol | acid | Ethanol |
| hours | %, w/w | g/L | g/L | g/L | g/L | g/L | g/L | g/L | %, v/v |
| 0 | 12.7 | 0.94 | 5.84 | 62.00 | 8.13 | nd | 3.83 | 2.43 | 0.05 |
| 24 | na | 0.92 | 4.45 | 0.78 | 7.02 | 1.15 | 7.08 | 3.95 | 3.01 |

TABLE 12
Shake Flask Fermentation of C6 Syrup 9% Dry Solids and Concentrated 2X

| | Oven Dry | | | | | Lactic | | Acetic | |
|---|---|---|---|---|---|---|---|---|---|
| Time | Solids | DP3 | DP2 | Dextrose | Xylose | acid | Glycerol | acid | Ethanol |
| hours | %, w/w | g/L | g/L | g/L | g/L | g/L | g/L | g/L | %, v/v |
| 0 | 18.0 | 1.51 | 10.74 | 100.77 | 14.66 | 0.28 | 9.31 | 3.56 | 0.07 |
| 7 | na | 1.45 | 10.65 | 57.43 | nr | 0.46 | 8.11 | 3.51 | 2.07 |
| 24 | na | 1.74 | 8.60 | 1.36 | 15.05 | 0.75 | 13.37 | 5.09 | 6.00 |

TABLE 13
Shake Flask Fermentation of C6 Syrup
16.5% Dry Solids with Several Strains of Saccharomyces cerevisiae

| Time | | Oven Dry | Dextrose | Xylose | Lactic | Glycerol | Acetic | Ethanol |
|---|---|---|---|---|---|---|---|---|
| hours | Strain | Solids (%) | g/L | g/L | g/L | g/L | g/L | %, v/v |
| 0 | None | 16.5 | 125.6 | 17.3 | 0.1 | 3.6 | 5.6 | 0.0 |
| 24 | 134-12 | Na | 1.6 | 12.7 | 0.6 | 8.8 | 5.2 | 6.8 |
| 24 | 424a | Na | 0.4 | 10.5 | 0.4 | 9.4 | 5.6 | 7.1 |
| 24 | ER2 | Na | 1.6 | 13.7 | 1.4 | 8.2 | 5.6 | 6.8 |
| 24 | Y500 | Na | 1.7 | 13.2 | 0.4 | 8.3 | 5.8 | 6.8 |
| 48 | 134-12 | Na | 1.4 | 8.4 | 0.7 | 8.8 | 6.2 | 6.9 |
| 48 | 424a | Na | 1.6 | 6 | 0.4 | 9.3 | 7.3 | 6.9 |
| 48 | ER2 | Na | 1.5 | 12.8 | 1.4 | 8.5 | 7.5 | 6.8 |
| 48 | Y500 | Na | 1.5 | 11.1 | 0.5 | 8.9 | 7.9 | 6.6 |

TABLE 14
Shake Flask Fermentation of C6 Syrup
20% Dry Solids with Recombinant Saccharomyces cerevisiae strain 424a

| | Halogen | | | | | Lactic | | Acetic | |
|---|---|---|---|---|---|---|---|---|---|
| Time | Dry Solids | DP3 | DP2 | Dextrose | Xylose | acid | Glycerol | acid | Ethanol |
| Hours | %, w/w | g/L | g/L | g/L | g/L | g/L | g/L | g/L | %, v/v |
| 29 | | 1.4 | 675 | 1.0 | 20.4 | nd | 17.1 | 0.9 | 8.3 |
| 48 | | 1.5 | 7.9 | 2.1 | 22.2 | nd | 16.5 | 0.9 | 8.0 |

An alternative process that can be used is referred to as simultaneous saccharification and fermentation (abbreviated: SSF). In such a process, the enzymatic digestion of the hemicellulose fraction 289 or the cellulose pulp fraction 218 is done in a medium that also includes the microorganisms. As the sugars are being released by the digestion process, they are consumed by the microorganisms for biomass accumulation and/or fermentation product production. Optionally a separate sugar source may also be fed to the digesting/fermentation mixture during the process. One benefit of an SSF process is that the consumption of the released sugars prevents feedback inhibition of any digesting enzymes that may be sensitive to feedback inhibition by the sugar. The SSF process can be carried out at a pH of 4-6 at 30-60° C. for 5 to 7 days depending on the enzyme dosing, composition of enzyme blend used, thermostability of the enzymes, thermal and inhibitor tolerance of the microorganisms used as well as the starting concentrations of dry solids in fermentation. A SSF shake flask experiment was done using the C6 syrup obtained from digesting the cellulose pulp 218 at high enzyme/high solids (20%) at 40° C. Results of SSF shake flask experiment are shown in Table 15, where the shake flasks with 20% w/w dry solids cellulose pulp 218 were not digested to the point of liquefaction in 24 hours and could not be sampled.

TABLE 15
Shake Flask Simultaneous Saccharification and Fermentation at 40° C.

| | | | | Lactic | | Acetic | |
|---|---|---|---|---|---|---|---|
| Time | Dry Solids | Dextrose | Xylose | acid | Glycerol | acid | Ethanol |
| hours | %, w/w | g/L | g/L | g/L | g/L | g/L | %, v/v |
| 24 | 15 | 4.7 | 16.8 | 0.4 | 14.2 | 1.6 | 5.51 |
| 24 | 20 | Not liquefied | | | | | |
| 48 | 15 | 2.0 | 18.0 | 0.4 | 15.0 | 2.1 | 6.30 |
| 48 | 20 | 10.8 | 21.7 | 0.4 | 14.0 | 1.6 | 6.58 |
| 96 | 15 | 4.9 | 21.7 | 0.5 | 16.3 | 2.4 | 4.19 |
| 96 | 20 | 23.1 | 25.6 | 0.5 | 14.8 | 1.8 | 5.61 |
| 120 | 15 | 5.4 | 24.5 | 0.6 | 17.6 | 2.5 | 3.11 |
| 120 | 20 | 28.0 | 29.7 | 0.6 | 16.6 | 2.0 | 4.38 |

A variation of a SSF process, is a semi SSF process wherein the fermentation is conducted in stages, typically, but not necessarily with different feedstocks. In a first stage a typical SHF is conducted using as the feedstock a C5 or C6 syrup pre-prepared by hydrolysis of the soluble hemicellulose 289 and cellulose pulp 218. In this initial phase biomass is accumulated with or without making the desired fermentation product. In a second phase the fermentation media containing the accumulated biomass is added to medium containing the hemicellulose 289 or cellulose pulp 218 in the presence of the hydrolyzing enzymes so that fermentation of the released sugars is occurring simultaneously with their hydrolytic release by the enzymes.

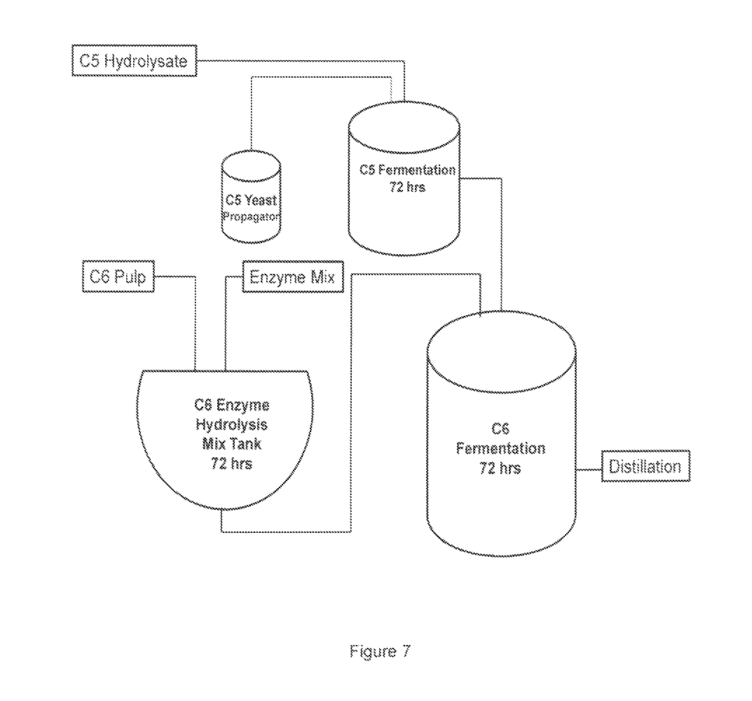

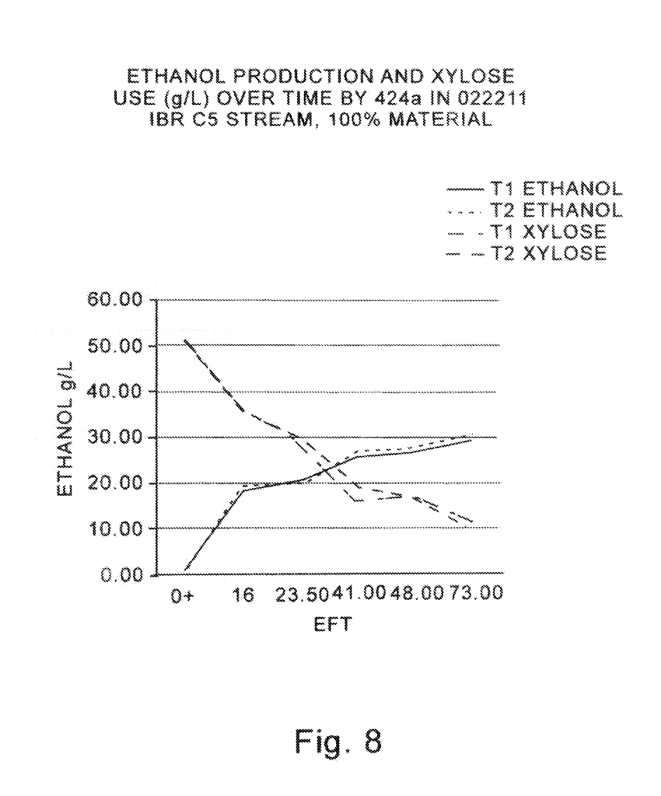

FIG. 7 illustrates one optimal method for a two stage semi-SSF process. In the first phase a first portion of C5 enriched syrup obtained from enzymatic hydrolysis of the soluble hemicellulose fraction 218, is used to accumulate biomass by aerobic growth in a microorganism propagator. In the illustrated embodiment, the yeast is a C5 competent ethanologen such as yeast strain 424a capable of producing ethanol from C5 sugars. The propagated yeast is then used to inoculate a fermentation media fed with a second portion of the C5 enriched syrup and grown anaerobically for a sufficient time to exhaust the sugars and produce a first portion of ethanol. FIG. 8 is a graph illustrating the time course for production of ethanol and simultaneous utilization of the C5 sugar xylose during an exemplary first stage conducted in laboratory shake flasks in duplicate.

Meanwhile, in preparation for the second phase, the cellulose pulp 218 made as described herein, is treated with a cellulolytic enzyme cocktail for a time sufficient to partly release a first portion of C6 sugars from the cellulose pulp 218. In the second phase, the yeast culture resulting from anaerobic fermentation on the C5 enriched syrup mentioned above is used to inoculate a larger medium containing the partly digested cellulose pulp and first portion of C6 sugars. This second phase of fermentation is continued under anaerobic conditions for a time sufficient to further hydrolyze the cellulose pulp into further C6 sugars and to produce ethanol. This method will produce a sufficient concentration of ethanol (at least 8% v/v) to make it economical for distillation and recovery.

Such a semi-SSF process conducted in two stages in a laboratory test. The first stage used a fermentation broth obtained by fermentation of the xylose fermenting yeast 424a on a C5 syrup obtained from enzymatic digestion of a hemicellulose fraction 289 from corn stover in a non-baffled shake flask containing 50 ml of the detoxified C5 syrup. The C5 syrup was treated to remove toxic degradation products that are formed during the pretreatment such as furfural, hydroxymethyl furfural (HMF), phenolics, organic acids consisting primarily of acetic acid, and other organics by using a combination of solvent extraction to remove furfural, HMF and phenolics, ion-exchange chromatography using charged resins to remove acids, and/or evaporation to strip off volatile components. An inoculum of 25% was used for a second medium containing the C5 syrup in sealed flasks rotated at 100 rpms that was incubated at 30° C. under anaerobic growth conditions. After 72 h, the broth from this stage was used to inoculate 150 ml of a medium containing a corn stover cellulose pulp 218 that was pretreated for 72 hr with a cellulolytic enzyme cocktail. This cellulolytic cocktail consisted of enzymes described in paragraph 0027. As shown in Table 16, after 72 hr of fermentation of the C6 syrup/pulp, a production of about 8.8% v/v of ethanol was obtained in duplicate with a concomitant utilization of 98.5% of the available glucose and about 57% of the available xylose.

TABLE 16
Shake Flask Semi-Simultaneous Saccharification and
Fermentation of C5 Syrup and C6 Syrup

| | | | Lactic | | Acetic | |
|---|---|---|---|---|---|---|
| | Glucose | Xylose | acid | Glycerol | acid | Ethanol |
| Time | g/L | g/L | g/L | g/L | g/L | %, v/v |
| 0 | 147.0 | 13.7 | 0.4 | 0.3 | 6.6 | |
| 72 | 2.0 | 7.3 | 2.5 | 7.3 | 8.0 | 8.4 |
| 72 | 2.4 | 8.1 | 2.0 | 8.1 | 8.7 | 8.8 |

The examples that follows are for purposes of illustration of steps taken in exemplary practices of certain aspects of the present disclosure and are not intended to limit or exemplify all ways in which the invention may be embodied by one of ordinary skill in the art.

### EXAMPLE 1

### Acetic Acid/Ethyl Acetate Processing of Corn Stover

1.5 kg of corn chopped stover having 92% solids content (1380 grams) and 8% moisture was added to a jacketed rotary reactor. Fifteen-2.5 inch (500 g) ceramic balls and 7 liters of 70% acetic acid were added and the reactor was closed. Reactor rotation was started and steam injected into the jacket. In 10 minutes, the internal reactor temperature reached 165° C. The temperature was held for 2 minutes and then steam injection was discontinued. Steam was slowly released from the jacket to lower the internal temperature of the reactor to 150° C. over 3 minutes. The reactor was then allowed to cool over a period of ½ hour to 100° C. Thereafter, cooling water was added to bring the reactor temperature to 60° C. and the reactor was opened. The cooked stover was filtered over a Buchner funnel and pressed. Five liters of an acetic acid hydrolysate filtrate was collected. Five liters of 99% acetic acid warmed to a temperature of 50° C. was used to solubilize and to wash residual lignin and hemicellulose from the cake and collected separately. Four liters of ethyl acetate was added to wash the cake of acetic acid and the wash was filtered to obtain an ethyl acetate filtrate and cake. The cake was removed from the funnel, fluffed and air dried forming Sample A (810 grams).

The acetic acid first filtrate was evaporated to 1.2 liters. The second acetic acid filtrate was added to the first and evaporated again to a final volume of 1.2 liters. The ethyl acetate filtrate was added to the evaporated hydrolysate mixture and this was evaporated to a syrup of ˜800 ml. This warm syrup was added to 2 liters of ethyl acetate to precipitate out the hemicellulose and lignin (Sample B, 475 grams). The filtrate was concentrated to a heavy syrup and added to 600 ml ethyl acetate to precipitate another 50 grams of material (Sample C). The residual filtrate was evaporated to a heavy syrup containing 210 grams dissolved solids (Sample D). Ten grams of sample B was dispersed and put into 65 ml of hot water to dissolve the water soluble fraction then filtered and the filtrate was retained (Sample E).

These samples were analyzed for dissolved solids, hydrolyzed sugar forms, metals, N, P and K as well as acetic acid. The tables below summarizes the results for various analysis reported in g/Kg unless otherwise indicated.

TABLE 17
Dissolved solids for Sample A

| Sample ID A | Glucan | Xylan | Mannan | Galactan | ASH |
|---|---|---|---|---|---|
| pulp AS IS | 530.3 | 106.8 | 6.9 | 22.7 | 96.4 |
| pulp Dry Basis | 532.4 | 107.2 | 6.9 | 22.7 | 96.7 |

| | Acid Insoluble | Acid Soluble | Free | Free | Bound | Free | Dry |
|---|---|---|---|---|---|---|---|
| Sample ID A | Lignin | Lignin | Dextrose | Xylose | Acetate | Acetate* | Solids* |
| pulp AS IS | 39.8 | 12.1 | 0.3 | 0.7 | 29.7 | 15.4 | 996.2 |
| pulp Dry Basis | 39.9 | 12.2 | 0.3 | 0.7 | 29.8 | | |

TABLE 18
Inorganic elements for Samples B-D

| Sample | Al | P | S | Zn | Co | Ni | Fe | Cr | Mg |
|---|---|---|---|---|---|---|---|---|---|
| Name | mg/kg | mg/kg | mg/kg | mg/kg | mg/kg | mg/kg | mg/kg | mg/kg | mg/kg |
| B | 123 | 4220 | 1970 | 69.1 | 1.25 | 3.74 | 1330 | 28.5 | 6700 |
| C | 14.8 | 556 | 1040 | 35.0 | 0.358 | 1.28 | 171 | 8.87 | 1120 |
| D | 0.289 | 94.0 | 297 | 4.12 | nd | nd | 2.58 | 0.604 | 38.0 |
| Sample | Ca | Cu | Na | K | Mn | Mo | B | N | Ash |
| Name | mg/kg | mg/kg | mg/kg | mg/kg | mg/kg | mg/kg | mg/kg | % | % |
| B | 5720 | 13.6 | 43.9 | 44800 | 159 | 0.907 | 16.8 | 1.63 | 8.9% |
| C | 1590 | 25.5 | 52.2 | 43500 | 24.8 | 0.586 | 6.27 | 1.65 | 9.1% |
| D | 147 | 4.96 | 29.1 | 18600 | 1.12 | nd | 0.604 | 0.411 | 3.6% |

TABLE 19
Sugar analysis Samples B-D

| | C5 | C6 | C5 | C6 | |
|---|---|---|---|---|---|
| | sugars | sugars | sugars | sugars | Acid |
| | (as is) | (as is) | (hydrolyzed) | (hydrolyzed) | insolubles* |
| Sample info | mg/kg | mg/kg | mg/kg | mg/kg | % |
| Sample B: | 42.215 | 36.109 | 354.960 | 99.387 | 25.8 |
| lignin/ | | | | | (2.61% N; |
| hemicellulose | | | | | 4.6% Ash) |
| precipitate 1 | | | | | |
| Sample C: | 57.034 | 34.067 | 249.980 | 72.546 | 45.5 |
| lignin/ | | | | | (1.59% N; |
| hemicellulose | | | | | 2.2% Ash) |
| precipitate 2 | | | | | |
| Sample D: | 18.355 | 11.450 | 41.235 | 11.457 | 32.7** |
| residual syrup | | | | | (0.59% N; |
| (49.75% DS) | | | | | 6.3% Ash) |

TABLE 20
Miscellaneous analysis Samples B-D

| | | | Other | | Acetic | Ethyl | HMF + | |
|---|---|---|---|---|---|---|---|---|
| | Sulfur | Potassium | metals | | Acid | Acetate | AcMF | Furfural* |
| Ash % | g/kg | g/kg | g/kg | Nitrogen % | g/kg | g/kg | g/kg | g/kg |
| 8.91 | 1.97 | 44.80 | 18.43 | 1.63 | 76.8 | NA | 1.68 | 0.34 |
| (1.14 acid | | | | | | | | |
| insoluble) | | | | | | | | |
| 9.14 | 1.04 | 43.50 | 3.61 | 1.65 | 55.8 | NA | 9.43 | 0.29 |
| (1.00 acid | | | | | | | | |
| insoluble) | | | | | | | | |
| 3.63 | 0.30 | 18.60 | 0.32 | 0.41 | 301.7 | 181.5 | 20.18 | 6.98 |
| (2.06 acid | | | | | | | | |
| insoluble) | | | | | | | | |

*HMF = HydroxyMethylFurfural, AcMF = AcetoxyMethylFurfural (acetic ester of HMF)

TABLE 21
Sugars, lignin, acetic acid and elements in Sample E

| | | | | C5 | C6 | | | | | | | |
|---|---|---|---|---|---|---|---|---|---|---|---|---|
| | | C5 | C6 | sugars | sugars | | | | | | | |
| | | sugars | sugars | (hydro- | (hydro- | | | | Other | | Acetic | Soluble |
| Sample | | (as is) | (as is) | lyzed) | lyzed) | | S | K | metals | | Acid | Lignin |
| info* | D.S. % | mg/kg | mg/kg | mg/kg | mg/kg | Ash % | g/kg | g/kg | g/kg | N % | g/kg | g/kg |
| Sample E- | 11.4 | 6,919 | 5,763 | 43,360 | 12,204 | 1.2 | 0.2 | 5.7 | 7.9 | 0.2 | 12.2 | 2.8 |
| aqueous | | | | | | | | | | | | |
| fraction | | | | | | | | | | | | |

### EXAMPLE 2

### Liquid/Liquid Separation of Acetic Acid/Ethyl Acetate Processed Corn Stover

Chopped corn stover was contacted with 70% acetic acid, heated, and filtered substantially as outlined in Example 1. The filtrate was concentrated by evaporation to 40% dissolved solids, forming a concentrated hemicellulose and lignin aqueous phase. Concentrated hemicellulose and lignin aqueous phase (1250 ml) was contacted with a first amount of ethyl acetate (1250 ml), which was carefully adjusted to prevent formation of a precipitate and induce phase separation, and mixed. The mixture readily separated into two phases: The lower phase comprised a gummy heavy aqueous phase containing most of the sugars and the organic-insoluble lignin (about half of the lignin) and reduced in acetic acid content. The upper phase comprised an organic supernatants phase containing organic soluble lignin, acetate salts, ethyl acetate and acetic acid. After the organic supernatants phase was decanted, the volume of the heavy aqueous phase was about 500 ml. The heavy aqueous phase was contacted (washed) with ethyl acetate (500 ml) and mixed at 50° C. More acetic acid again partitioned into the ethyl acetate phase, causing a further decrease in the amount of acetic acid in the sugar- and lignin-containing heavy aqueous phase. The mixture separated again, forming a second organic supernatant over the heavy aqueous phase; the second organic supernatant was decanted. Ethyl acetate (500 ml) was again contacted with the heavy aqueous phase with mixing at 50° C. The mixture separated again, forming a first phase comprising a washed heavy aqueous phase and a third organic supernatant. After decanting the third organic supernatant, the organic supernatants were combined and mixed, forming a second phase comprising organic supernatants; a small amount of tarry precipitate formed and was separated and added to the washed heavy aqueous phase.

The washed heavy aqueous phase was contacted with water sufficient to induce precipitation of lignin (1250 ml), whereupon a fluffy precipitate of organic-insoluble lignin formed. The mixture was heated to 94° C. with mixing, whereupon the fluffy precipitated lignin coagulated. The mixture was allowed to cool to 50° C. under mixing, and then filtered. After filtration, a lignin cake was obtained; the lignin cake was washed with 400 ml of water and dried to yield organic-insoluble lignin (100 grams dry solids). The filtrate comprising hemicellulose/sugar enriched fraction (Sample F, 1650 mL, Table 22) contained only 6.1% acetic acid.

TABLE 22
Dry solids, sugars, lignin, acetic acid and elements in Sample F. “As is” denotes
free sugars; “hydrolyzed” denotes sugars recovered after analytical hydrolysis.

| | | C5 | C6 | | | | | | | |
|---|---|---|---|---|---|---|---|---|---|---|
| | | sugars | sugars | C5 sugars | C6 sugars | | | | Other | Acetic |
| | Dry | (as is) | (as is) | (hydrolyzed) | (hydrolyzed) | Total | S | K | metals | Acid |
| Sample info | Solids % | mg/kg | mg/kg | mg/kg | mg/kg | Ash % | g/kg | g/kg | g/kg | g/kg |
| Hemicellulose/ | 16.5 | 15,081 | 5,777 | 78,642 | 20,202 | 1.60 | 0.17 | 6.16 | 4.08 | 61.1 |
| sugar enriched | | | | | | | | | | |
| fraction F | | | | | | | | | | |

A subsample of hemicellulose/sugar enriched fraction was acidified to pH 2.8 with sulfuric acid and contacted with an equal volume of ethyl acetate. The ethyl acetate extraction easily removed the small amount of remaining acetic acid, as two liquid phases formed and easily separated without emulsion formation. A third phase comprising acetic acid-depleted C5+C6 sugars containing 36.9 g/kg acetic acid formed and was easily removed. The acetic acid-depleted C5+C6 sugars phase was re-extracted with ethyl acetate, further reducing the acetic acid content to 23.3 g/kg. The two ethyl acetate fractions can be combined to form an organic fourth phase comprising recovered acetic acid. The acetic acid-depleted C5+C6 sugars phase was enriched in C5 and C6 sugars and was suitable for fermentation due to the low content of acetic acid.

The second phase comprising organic supernatants was subjected to evaporation to recover ethyl acetate and acetic acid separate from an aqueous supernatant syrup (0.4 parts, Tables 23 and 24, Sample G). The aqueous supernatant syrup was enriched in organic-soluble lignin and acetate salts and reduced in content of ethyl acetate and acetic acid. Aqueous supernatant syrup was contacted with an equal volume of water to form a two-phase mixture comprising an aqueous fifth phase enriched in acetate salts and a sixth phase enriched in organic-soluble lignin. The two-phase mixture was heated to 90° C. with stirring to evaporate ethyl acetate and extract water-soluble components, such as acetate salts, into the aqueous fifth phase. On cooling to 40° C. the aqueous fifth phase was removed. The water-wash of the sixth phase was repeated twice more. The water-washed organic sixth phase was cooled, ground and dried to yield organic soluble lignin powder (135 grams). The aqueous fifth phase was combined with the wash water and evaporated to an aqueous acetate salt solution (144 grams). This aqueous phase may be dried and used for fertilizer.

By conducting liquid/liquid separations in this manner, chopped corn stover was fractionated into acetic acid-depleted C5+C6 sugars, an organic-soluble lignin, an organic-insoluble lignin, and an aqueous acetate salt solution. In addition, emulsion formation was prevented, substantially reduced volumes of ethyl acetate were used, and both ethyl acetate and acetic acid were easily recovered.

### EXAMPLE 3

### Liquid/Liquid Separation of Acetic Acid/Ethyl Acetate Processed Corn Stover

Corn stover (1500 grams, 92% dry solids) was hydrolyzed at 163-171° C. for 10 minutes in the rotary reactor with 7.5 liters of ˜70% acetic acid solution substantially as outlined in Example 1. The reactor was cooled to 121° C. over a period of 30 minutes, and cooled to 60° C. with cooling water over a period of 10 minutes. The cooked stover was pressed and filtered to recover a first hydrolyzate separate from an acetylated lignocellulose cake. The acetylated lignocellulose cake was contacted with a second amount of acetic acid by contacting it three times with one liter of 70% acetic acid at 60° C. and filtered to yield an acid washed acylated lignocellulose cake (about 1.5 liters in volume), and about 8 liters of acid wash. The acid washed acetyl cellulose cake was contacted twice with one liter of ethyl acetate and filtered to recover about 3 liters of ethyl acetate wash separate from an ethyl acetate washed acetyl cellulose pulp (about 1.5 liters). The ethyl acetate wash was combined with the first acid hydrolyzate to form an acidic organic solvent extract comprising combined acetic solubles. Acetic acid was recovered from the acidic organic solvent extract comprising combined acetic solubles by evaporating it to 1.3 liters, forming a concentrated hemicellulose and lignin aqueous phase enriched with hemicellulose and lignin (Evaporate (concentrate)). This was combined with the ethyl acetate wash from acid washed acetylcellulose, and ethyl acetate was condensed by evaporation to 1 liter volume, forming a concentrated hemicellulose and lignin aqueous phase enriched with hemicellulose and lignin (Tables 23-25, sample H, density 1.25 g/ml). The concentrated hemicellulose and lignin aqueous phase (sample H) comprised 37% acetic acid and 52.9% dry solids. The dry solids contained 5.39% C5 sugars, 0.76% C6 sugars, and 15.5% and 4.2% C5 and C6 sugars, respectively, obtained after hydrolysis of polysaccharides; this corresponded to a 23.8% degree of hydrolysis of hemicellulose in the initial hydrolytic treatment.

To effect separation of the concentrated hemicellulose and lignin aqueous phase by liquid/liquid separation, a second amount of ethyl acetate was contacted with the concentrated hemicellulose and lignin aqueous phase. This amount of ethyl acetate (1.5 liters of ethyl acetate added to one liter of concentrated hemicellulose and lignin) was chosen to induce phase separation and prevent formation of a precipitate. The mixture was allowed to separate into a washed heavy aqueous phase containing most of the C5 sugars and C6 sugars with the organic-soluble lignin (Tables 23-25, sample I, 61.6% dry solids, 700 ml), and a second phase comprising organic supernatants comprising organic soluble lignin, acetate salts, ethyl acetate, and acetic acid (Tables 23-24, sample J, 12.3% dry solids, 1780 ml).

Heavy aqueous phase (400 ml, Tables 23-25, Sample I) was contacted with water (800 ml, room temperature water) and stirred. After settling for 45 minutes, a clear brown solution (about 1200 ml) and a precipitate (200 ml) were observed. The upper phase (water-washed heavy aqueous phase enriched in C5 sugars and C6 sugars) was decanted and the precipitate was extracted with 300 ml of water and filtered to yield a cake of organic-insoluble lignin. The filtrate was added to the water-washed heavy aqueous phase enriched in C5 sugars and C6 sugars to form a C5+C6 sugar syrup (hemicellulose stream, 1650 ml, 9.7% dry solids, Tables 23-25, sample K).

Supernatant J was condensed by evaporated to yield a condensate of ethyl acetate and acetic acid and form an aqueous supernatant syrup (300 ml). Aqueous supernatant syrup was held at 70° C. and contacted (stirred) with an equal volume of 70° C. water to form a two-phase mixture. This mixture was allowed to cool to 40° C. without a step of heating to 90° C. The upper water phase was decanted and the lower organic phase was washed two times with 300 ml of hot water. The water-washed organic phase containing organic soluble lignin was collected and allowed to cool and solidify (295 grams). The water phases were combined to yield a solution of acetate salts (1000 ml, 4.3% dry solids, Tables 23-25, sample L). Compositional information about samples G-L is given in Tables 23-25.

By conducting liquid/liquid separations in this manner, chopped corn stover was fractionated into a water-washed heavy aqueous phase enriched in C5 sugars and C6 sugars and reduced in content of acetic acid, organic-insoluble lignin, organic-soluble lignin, a solution of acetate salts, and a solution of recovered ethyl acetate with acetic acid. In addition, emulsion formation was prevented, the use of sulfuric acid was obviated, and substantially reduced volumes of ethyl acetate were used.

TABLE 23
Sugar analysis Samples G-L

| | | | C5 | C6 | C5 | C6 |
|---|---|---|---|---|---|---|
| | | Dry | sugars | sugars | sugars | sugars |
| | | Solids | (as is) | (as is) | (hydrolyzed) | (hydrolyzed) |
| Sample | | % | % | % | % | % |
| G | | 7.0 | 0.83 | 0.19 | 2.00 | 0.53 |
| H | (268) | 52.9 | 5.39 | 0.76 | 15.46 | 4.24 |
| I | (312) | 61.6 | 8.35 | 1.17 | 22.07 | 6.62 |
| J | (316) | 12.3 | 0.70 | 0.09 | 0.54 | 0.07 |
| K | (352) | 9.7 | 1.77 | 0.27 | 5.01 | 1.06 |
| L | | NA | 1.00 | 0.10 | NA | NA |

TABLE 24
Miscellaneous analysis Samples G-L

| | | | | Other | | | | |
|---|---|---|---|---|---|---|---|---|
| Sample | Total | Sulfur | Potassium | metals | Acetic | Ethyl | | |
| info | Ash % | g/kg | g/kg | g/kg | Acid % | Acetate % | HMF % | Furfural % |
| G | NA | NA | NA | NA | 57.1 | 0.20 | 0.04 | 1.03 |
| H | 0.00 | 0.50 | 0.00 | 0.00 | 36.6 | 0.60 | NA | NA |
| I | 0.00 | 0.55 | 0.00 | 0.00 | 15.7 | 11.20 | NA | NA |
| J | NA | NA | NA | NA | NA | NA | NA | NA |
| K | 0.00 | 0.09 | 0.00 | 0.00 | 4.1 | 2.70 | NA | NA |
| L | 0.00 | 0.03 | 0.00 | 0.00 | 6.1 | 0.70 | 0.17 | 0.08 |

TABLE 25
Inorganic elements and ash for Samples H, I, K and L

| | Al | P | S | Zn | Co | Ni | Fe |
|---|---|---|---|---|---|---|---|
| Sample | mg/kg | mg/kg | mg/kg | mg/kg | mg/kg | mg/kg | mg/kg |
| H | 91.6 | 863 | 503 | 34.1 | 0.258 | 1.72 | 300 |
| I | 152 | 1272 | 550 | 33.2 | 0.322 | 1.78 | 467 |
| K | 40.2 | 397 | 90.0 | 11.7 | ND | 0.640 | 110 |
| L | 0.414 | 14.3 | 32.5 | 6.23 | ND | ND | 2.42 |

| | Cr | Mg | Ca | Cu | Na | K | Mn | Mo | B | Ash |
|---|---|---|---|---|---|---|---|---|---|---|
| Sample | mg/kg | mg/kg | mg/kg | mg/kg | mg/kg | mg/kg | mg/kg | mg/kg | mg/kg | % |
| H | 1.96 | 1371 | 2581 | 1.41 | 8.34 | 13877 | 65.1 | ND | 4.59 | 8.0 |
| I | 1.76 | 1840 | 3463 | 1.51 | 6.48 | 19575 | 91.4 | ND | 5.55 | 2.5 |
| K | ND | 618 | 1046 | ND | 11.0 | 4547 | 29.4 | ND | 6.61 | 1.0 |
| L | ND | 53.2 | 171 | ND | 19.8 | 2535 | 2.57 | ND | 6.82 | 0.4 |

### SELECTED REFERENCES

K. P. Vogel, J. F. Pederson, S. D. Masterson, J. J. Troy. Evaluation of a filter bag system for NDF, ADF and IVDMD forage analysis. Crop Science. 39, 276-279 (1999).

J. B. Sluiter, R. O. Ruiz, C. J. Scarlata, A. D. Sluiter, D. W. Templeton. Compositional analysis of lignocellulosic feedstocks. 1. Review and description of methods. J. Agric. Food Chem. 58, 9043-9053 (2010).

M. Sedlak, H. J. Edenberg, N. W. Y Ho. DNA microarray analysis of the expression of the genes encoding the major enzymes in ethanol production during glucose and xylose co-fermentation by metabolically engineered Saccharomyces host. Enz. Microbial Technol. 33, 19-28 (2003).

S. C. Bate, W. A. Rogerson, F. G. Peach 1953. Improvements in the production of cellulose and cellulose derivatives. Great Britain Patent 686311.

P. P. Rousu, J. R. Antilla, E. J. Rousu 2001. Method for the recovery of formic acid. U.S. Pat. No. 6,252,109.

J. C. Parajo, J. L. Alonso, D. Vazquez. On the behaviour of lignin and hemicelluloses during the Acetosolv processing of wood. Bioresource Technology 46, 233-240 (1993).

S. Abad, J. L. Alonso, V. Santo, J. C. Parajo. Furfural from wood in catalyzed acetic acid media: a mathematical assessment. Bioresource Technology 62, 115-122 (1997).

C. Vila, V. Santos, J. C. Parajo. Recovery of lignin and furfural from acetic acid—water—HCl pulping liquors. Bioresource Technology 90, 339-344 (2003).

M.-F. Li, S.-N. Sun, F. Xu, R.-C. Sun. Sequential solvent fractionation of heterogeneous bamboo organosolv lignin for value-added application. Separation and Purification Technology 101, 18-25 (2012).

S. Korom, Z. Fonyoi and O. M. Kut. Design strategy for acetic acid recovery. Chem. Eng. Comm. 136, 161-176 (1995).

C. Vila, V. Santos, J. C. Parajo. Simulation of an organosolv pulping process: generalized material balances and design calculations. Ind. Eng. Chem. Res. 42, 349-356 (2003).

P. Biely. Microbial carbohydrate esterases deacetylating plant polysaccharides. Biotechnol. Adv. 30(6), 1575-1588 (2102).

Z. Zu, A. Afacan, K. Chang. Removal of acetic acid from water by catalytic distillation. Part 2: Modeling and simulation studies. Can. J Chem. Eng. 77 682-687 (1999).

1. A method of processing lignocellulosic biomass, comprising:
a. contacting a lignocellulosic biomass with a first amount of acetic acid;
b. heating the contacted lignocellulosic biomass to a temperature and for a time sufficient to hydrolytically release a first portion of hemicellulose and lignin, forming a hydrolysate liquid and an acylated lignocellulose cake;
c. separating the acylated lignocellulosic cake from the hydrolysate liquid;
d. contacting the acylated lignocellulose cake with a second amount of the acetic acid to wash hemicellulose and lignin from the acylated lignocellulosic cake and separating an acid wash liquid from the acid washed acylated lignocellulosic cake;
e. contacting the acid washed acylated lignocellulose cake with a first amount of a C₁-C₂ acid-miscible organic solvent to wash the acetic acid, hemicellulose and lignin from the acid washed acylated lignocellulosic cake and recovering the C₁-C₂ acid-miscible solvent wash liquid separate from the solvent washed acylated lignocellulose cake;
f. combining the solvent wash liquid with at least one of the hydrolysate and the acid wash liquid forming an acidic organic solvent extract;
g. condensing the acidic organic solvent extract forming a concentrated hemicellulose and lignin aqueous phase enriched with hemicellulose and lignin; and,
h. adding to the concentrated hemicellulose and lignin aqueous phase a second amount of the C₁-C₂ acid-miscible organic solvent sufficient to induce phase partitioning into a first phase comprising a washed heavy aqueous phase enriched in C5 and C6 sugars and organic-insoluble lignin and a second phase comprising an organic supernatant phase comprising organic-soluble lignin, acetate salts, C₁-C₂ acid-miscible solvent, and acetic acid.

2. The method of claim 1 further comprising
a. contacting the washed heavy aqueous phase with an amount of water sufficient to induce precipitation;
b. heating the water-contacted washed heavy aqueous phase at a temperature and for a time sufficient to induce coagulation forming coagulated organic-insoluble lignin and a hemicellulose/sugar enriched fraction enriched in C5 and C6 sugars; and,
c. recovering the organic-insoluble lignin separate from the hemicellulose/sugar enriched fraction.

3. The method of claim 2 further comprising
a. contacting the hemicellulose/sugar enriched fraction with at least one acid to form an acidified hemicellulose/sugar enriched fraction; and,
b. contacting the acidified hemicellulose/sugar enriched fraction with an amount of a C₁-C₂ acid-miscible organic solvent sufficient to extract acetic acid from the C5 and C6 sugar syrup and induce phase partitioning into a third phase comprising an acetic acid-depleted C5 and C6 sugar syrup enriched in C5 and C6 sugars and reduced in content of acetic acid and a fourth organic phase comprising recovered acetic acid reduced in content of C5 and C6 sugars relative to the third phase.

4. The method of claim 1 further comprising
a. subjecting the second phase to evaporation to recover the C₁-C₂ acid-miscible organic solvent and acetic acid separate from an aqueous supernatant syrup enriched in organic-soluble lignin.

5. The method of claim 4 further comprising contacting the aqueous supernatant syrup with sufficient water to induce phase separation and obtain a fifth phase comprising an aqueous phase enriched in acetate salts and reduced in content of organic-soluble lignin and a sixth phase comprising a phase enriched in organic-soluble lignin.

6. The method of claim 1, wherein the condensing is by evaporation of the acetic acid and the C1-C2 acid-miscible organic solvent.

7. The method of claim 6 wherein the acetic acid and the C1-C2 acid-miscible organic are separated and recovered by distillation.

8. The method of claim 1 further comprising contacting a phase enriched in C5 and C6 sugars with a microorganism to make a desired fermentation product.

9. The method of claim 1 wherein the C1-C2 acid-miscible organic solvent is not a halogenated organic solvent.

10. A composition comprising an organic-insoluble lignin obtained by the method of claim 2.

11. A composition comprising an organic-insoluble lignin according to claim 10 wherein the C₁-C₂ acid-miscible organic solvent is ethyl acetate.

12. A composition obtained by the method of claim 2 wherein the organic-insoluble lignin comprises lignin derived from softwood, such as conifers, spruce, cedar, pine and redwood; lignin derived from hardwood, such as maple, poplar, oak, eucalyptus, and basswood; lignin derived from stalks, such as straw, maize, canola, oat, rice, broomcorn, wheat, soy, barley, spelt, and cotton; lignin derived from grass, such as bamboo, miscanthus, sugar cane, switchgrass, reed canary grass, cord grass, and combinations of any thereof.

13. A composition comprising an organic-soluble lignin obtained by the method of claim 5.

14. A composition obtained by the method of claim 5 wherein the organic-insoluble lignin comprises lignin derived from softwood, such as conifers, spruce, cedar, pine and redwood; lignin derived from hardwood, such as maple, poplar, oak, eucalyptus, and basswood; lignin derived from stalks, such as straw, maize, canola, oat, rice, broomcorn, wheat, soy, barley, spelt, and cotton; lignin derived from grass, such as bamboo, miscanthus, sugar cane, switchgrass, reed canary grass, cord grass, and combinations of any thereof.

15. The method of claim 1 wherein the lignocellulosic biomass has a water content not greater than 40% wt/wt.

16. The method of claim 1 wherein the lignocellulosic biomass has a water content not greater than 20% wt/wt.

17. The method of claim 1 wherein the lignocellulosic biomass has a water content not greater than 10% wt/wt.

18. (canceled)
